(19) United States
(12) Patent Application Publication
(10) Pub. No.: US 2016/0090076 A1
(43) Pub. Date: Mar. 31, 2016

(54) VEHICLE GEAR BOX AND CONTROL SYSTEM

(71) Applicant: TOYOTA JIDOSHA KABUSHIKI KAISHA, Aichi (JP)

(72) Inventors: Kimitoshi TSUJI, Susono-shi, Shizuoka-ken (JP); Kiyohito MURATA, Susono-shi, Shizuoka-ken (JP)

(73) Assignee: TOYOTA JIDOSHA KABUSHIKI KAISHA, Toyota-shi, Aichi (JP)

(21) Appl. No.: 14/782,691

(22) PCT Filed: Apr. 9, 2013
(86) PCT No.: PCT/JP2013/060746

§ 371 Date: Oct. 6, 2015

(51) Int. Cl. B60W 20/00; B60K 6/38; B60W 10/06; B60K 6/36; B60W 10/113; B60W 10/08

(52) U.S. Cl. CPC B60W 20/106; B60W 10/113; B60W 10/08; B60W 10/06; B60W 20/40; B60K 6/36; B60K 6/38; B60W 2510/244; B60W 2710/021; B60W 2710/0666; B60W 2710/086; Y10S 903/93; Y10S 903/946

(57) ABSTRACT

A vehicle gear box includes: a gear shift mechanism including a first engaging device configured to engage/disengage power transmission between an engine and a first input shaft of a first gear position group and a second engaging device configured to engage/disengage power transmission between the engine and a second input shaft of a second gear position group; a differential mechanism configured to connect a rotational shaft of a rotator and the first input shaft and the second input shaft; a third engaging device configured to engage/disengage power transmission between the engine and the first engaging device and the second engaging device; and a control system configured to control the third engaging device and the rotator to perform control that switches the third engaging device to be in a disengaged state and drives the vehicle by the rotary power output from the rotator.

### FIELD

The present invention relates to a vehicle gear box and a control system.

### BACKGROUND

Patent Literature 1 for example discloses, as a vehicle gear box and a control system mounted in a vehicle, a vehicle power transmission system which transmits rotation of an engine to a shift gear through either a first clutch shaft or a second clutch shaft while the vehicle is being driven. The vehicle power transmission system drives a motor generator and generates power by using a difference in rotational speeds between an input rotational speed of a shift gear used for driving and an input rotational speed of a shift gear used for a purpose other than driving. The vehicle power transmission system uses a planetary gear and a coupling gear to extract the difference between the input rotational speed of the shift gear used for driving and the input rotational speed of the shift gear used for a purpose other than driving, and connects to the motor generator to which a stator is fixed, for example.

### CITATION LIST

### Patent Literature

Patent Literature 1: Japanese Laid-open Patent Publication No. 2002-204504

### SUMMARY

### Technical Problem

The vehicle power transmission system disclosed in Patent Literature 1 as described above has room for further improvement in terms of increasing fuel efficiency, for example.

The present invention has been made in consideration of the aforementioned circumstances, where an object of the present invention is to provide a vehicle gear box and a control system capable of increasing the fuel efficiency.

### Solution to Problem

To achieve the above-described object, a vehicle gear box according to the present invention includes: a gear shift mechanism including: a first engaging device configured to engage/disengage power transmission between an engine generating rotary power that drives a vehicle and a first input shaft of a first gear position group; and a second engaging device configured to engage/disengage power transmission between the engine and a second input shaft of a second gear position group; a differential mechanism configured to connect a rotational shaft of a rotator and the first input shaft and the second input shaft to be able to rotate differentially; a third engaging device configured to engage/disengage power transmission between the engine and the first engaging device and the second engaging device; and a control system configured to control the engine, the first engaging device, the second engaging device, the third engaging device, and the rotator, wherein the control system is configured to control the third engaging device and the rotator to perform control that switches the third engaging device to be in a disengaged state and drives the vehicle by the rotary power output from the rotator.

Moreover, in the above-described vehicle gear box, the control system controls the engine and the rotator on the basis of a charged state of a power storage device configured to store power generated by the rotator, and to perform control that, at a time a state of charge of the power storage device is relatively high, decreases output of the engine relatively to a case where a state of charge of the power storage device is relatively low and drives the vehicle with rotary power output from the rotator.

Moreover, in the above-described vehicle gear box, the control system controls the first engaging device, the second engaging device, and the rotator to be able to switch a state between a stepped transmission state in which the rotary power from the engine is shifted in speed by any gear position included in the first gear position group or the second gear position group and is output from an output shaft, and a continuously variable transmission state in which the rotary power from the engine is shifted in speed by an intermediate gear ratio of a gear ratio of each gear position included in the first gear position group and the second gear position group and is output from the output shaft and in which the gear ratio can be continuously changed, the control system being configured to perform control to switch a state to either the stepped transmission state or the continuously variable transmission state with relatively higher efficiency and changing the gear ratio by controlling an amount of power generated by the rotator at a time in the continuously variable transmission state.

Moreover, in the above-described vehicle gear box, the control system controls each of the first engaging device and the second engaging device to be in an engaged state at a time of driving the vehicle by the rotary power output from the rotator while setting the third engaging device to be in a disengaged state.

Moreover, the above-described vehicle gear box includes: a first brake configured to brake rotation of the first input shaft; and a second brake configured to brake rotation of the second input shaft, wherein, at a time of driving the vehicle by the rotary power output from the rotator while setting the third engaging device to be in the disengaged state, the control system controls the first brake and the second brake in a way that the first brake and the second brake are switched to a disengaged state and a braking state, respectively, at a time the rotary power from the rotator is shifted in speed by any gear position included in the first gear position group and that the first brake and the second brake are switched to a braking state and a disengaged state, respectively, at a time the rotary power from the rotator is shifted in speed by any gear position included in the second gear position group.

Moreover, in the above-described vehicle gear box, at a time of controlling the engine and the rotator to generate power in the rotator by using power generated in the engine, the control system is configured to control output of the engine such that an operating point of the engine is positioned within an optimal fuel efficiency area of the engine while allowing for an amount of power generated by the rotator.

Moreover, in the above-described vehicle gear box, the control system is configured to perform control to drive the vehicle by the rotary power output from the rotator at a time the vehicle is driven steadily.

Moreover, in the above-described vehicle gear box, the control system determines that the vehicle is in a steady driving state at a time an amount of change in a parameter indicating a driving state of the vehicle is smaller than a preset steadiness determining reference value, which is relatively increased at a time a state of charge of a power storage device capable of storing power generated by the rotator is relatively high, and relatively decreased at a time the state of charge of the power storage device is relatively low.

Moreover, in the above-described vehicle gear box, the control system controls the engine and the rotator on the basis of a charged state of the power storage device capable of storing power generated by the rotator, and is configured to perform control that relatively decreases the amount of power generated by the rotator at a time the state of charge of the power storage device is relatively high and relatively increases the amount of power generated by the rotator at a time the state of charge of the power storage device is relatively low.

Moreover, in the above-described vehicle gear box, the control system is configured to perform control to generate power in the rotator by using power generated by the engine and store the power into the power storage device by increasing output of the engine relatively to a case where the state of charge of the power storage device is higher than a preset allowable lower limit value, at a time the state of charge of the power storage device capable of storing power generated by the rotator is lower than or equal to the allowable lower limit value while the vehicle is driven by the rotary power output from the rotator.

Moreover, in the above-described vehicle gear box, the control system is configured to perform control that controls the rotator to generate power by the rotary power transmitted to the rotator from the side of a driving wheel of the vehicle and stores the power into the power storage device at a time the vehicle is decelerated.

To achieve the above-described object, a control system according to the present invention for controlling a vehicle gear box including: a gear shift mechanism including: a first engaging device configured to engage/disengage power transmission between an engine generating rotary power that drives a vehicle and a first input shaft of a first gear position group; and a second engaging device configured to engage/disengage power transmission between the engine and a second input shaft of a second gear position group; a differential mechanism configured to connect a rotational shaft of a rotator and the first input shaft and the second input shaft to be able to rotate differentially; and a third engaging device configured to engage/disengage power transmission between the engine and the first engaging device and the second engaging device, wherein the control system is configured to control the third engaging device and the rotator to be able to perform control that switches the third engaging device to be in a disengaged state and drives the vehicle by the rotary power output from the rotator.

### Advantageous Effects of Invention

The vehicle gear box and the control system according to the present invention can increase the fuel efficiency.

### BRIEF DESCRIPTION OF DRAWINGS

FIG. 1 is a schematic block diagram of a vehicle equipped with a gear box according to a first embodiment.

FIG. 2 is a schematic diagram illustrating a transmission route of power in the gear box according to the first embodiment.

FIG. 3 is a diagram illustrating an example of an operating characteristic of an engine of a power train applying the gear box according to the first embodiment.

FIG. 4 is a flowchart illustrating an example of control performed in the gear box according to the first embodiment.

FIG. 5 is a diagram illustrating an example of an optimal fuel efficiency area map for the gear box according to the first embodiment.

FIG. 6 is a time chart illustrating an example of an operation of the gear box according to the first embodiment.

FIG. 7 is a diagram illustrating an example of a gear position efficiency map for a gear box according to a second embodiment.

FIG. 8 is a diagram illustrating an example of a differential mechanism efficiency map for the gear box according to the second embodiment.

FIG. 9 is a flowchart illustrating an example of control performed in the gear box according to the second embodiment.

FIG. 10 is a schematic block diagram of a vehicle equipped with a gear box according to a third embodiment.

### DESCRIPTION OF EMBODIMENTS

Embodiments according to the present invention will now be described in detail with reference to the drawings. The present invention is not to be limited by the embodiments. Components in the following embodiments include one that is easily replaceable by those skilled in the art or one that is substantially identical.

### First Embodiment

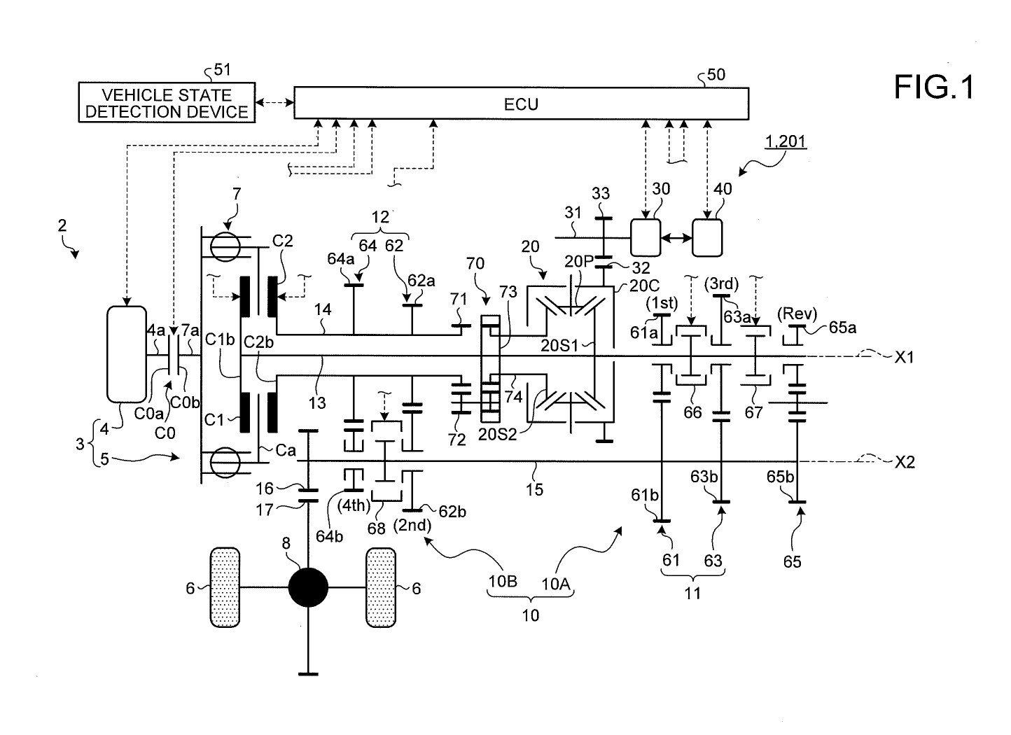

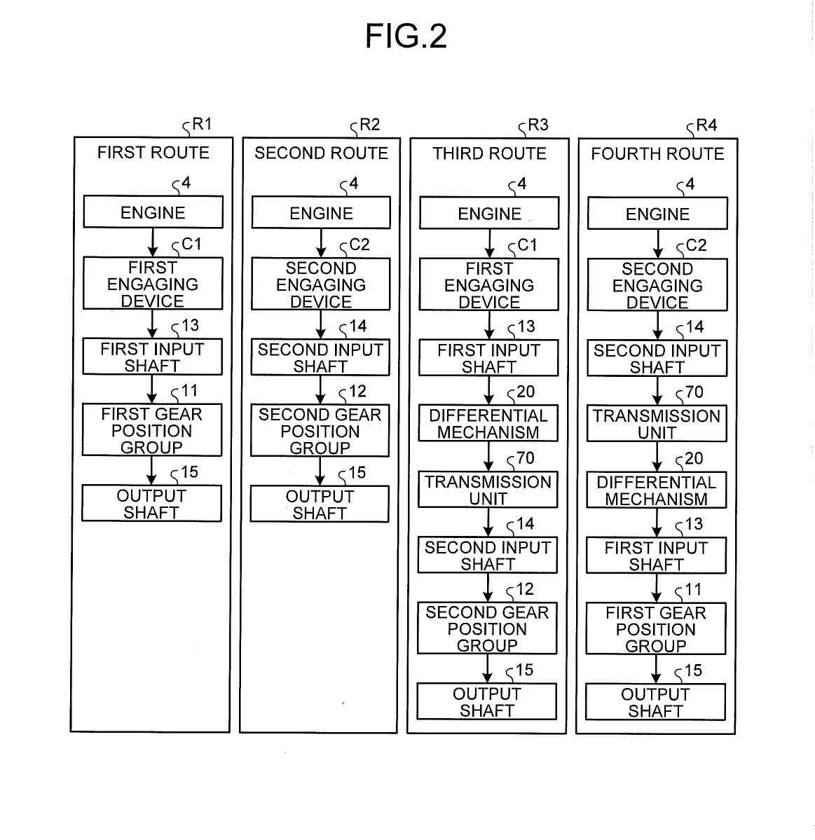

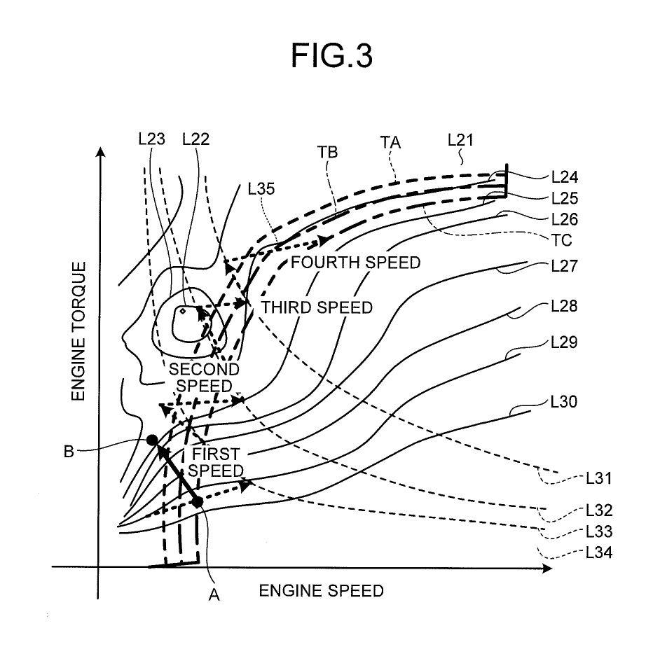

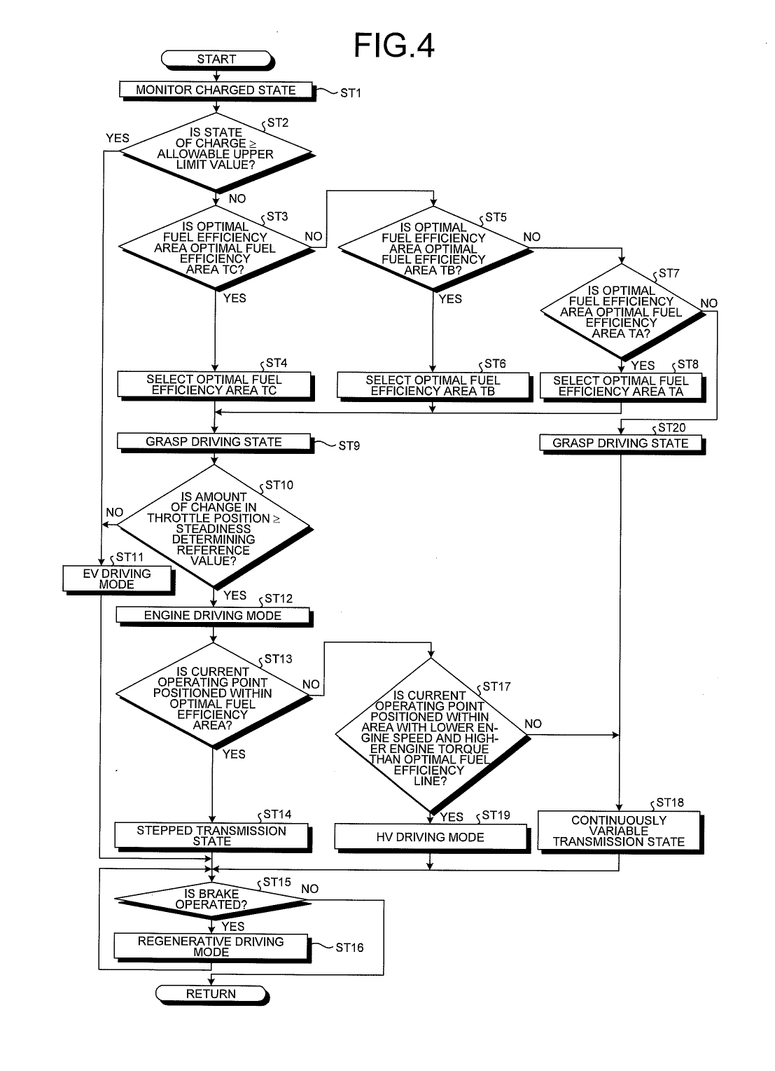

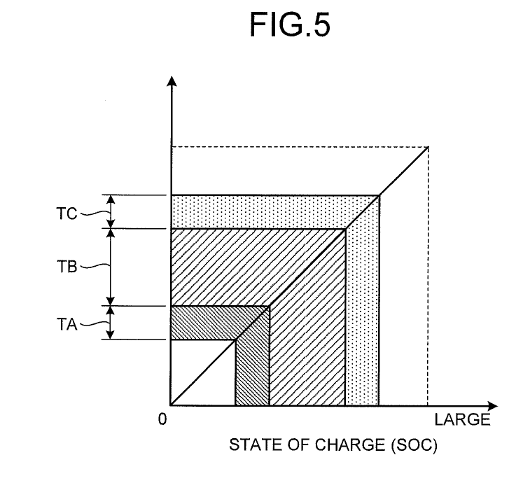

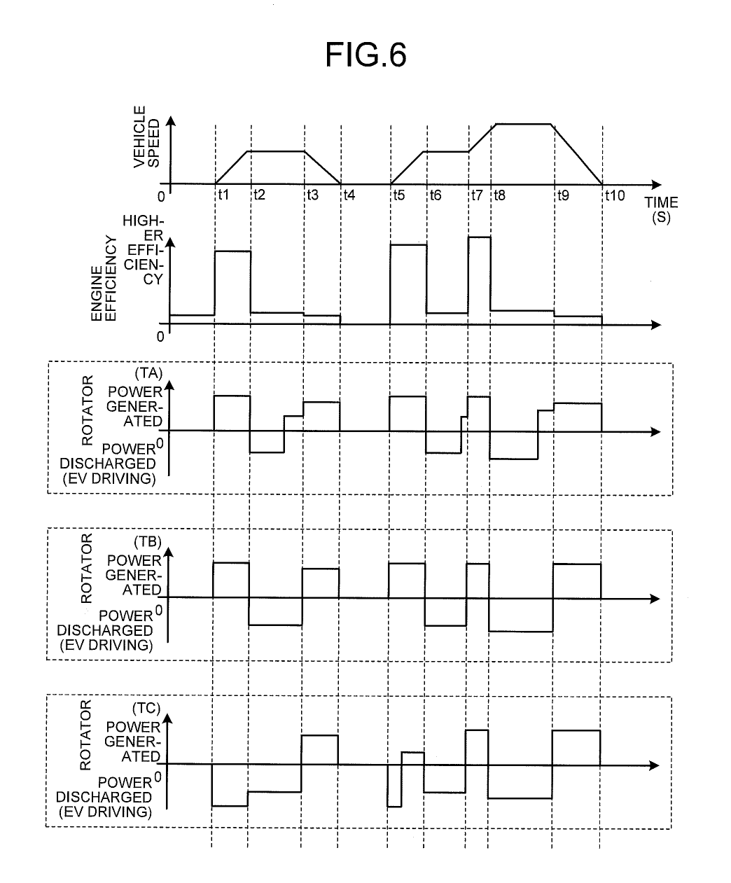

FIG. 1 is a schematic block diagram of a vehicle equipped with a gear box according to a first embodiment. FIG. 2 is a schematic diagram illustrating a transmission route of power in the gear box according to the first embodiment. FIG. 3 is a diagram illustrating an example of an operating characteristic of an engine of a power train applying the gear box according to the first embodiment. FIG. 4 is a flowchart illustrating an example of control performed in the gear box according to the first embodiment. FIG. 5 is a diagram illustrating an example of an optimal fuel efficiency area map for the gear box according to the first embodiment. FIG. 6 is a time chart illustrating an example of an operation of the gear box according to the first embodiment.

Note that in the following description, a direction along an axis of rotation is each called an axial direction, a direction orthogonal to the axis of rotation, namely a direction orthogonal to the axial direction, is each called a radial direction, and a direction around the axis of rotation is each called a circumferential direction, unless otherwise noted. The radial direction toward the axis of rotation is called an inner radial direction, while the radial direction away from the axis of rotation is called an outer radial direction.

A gear box 1 as a vehicle gear box of the present embodiment is applied to a power train 3 mounted in a vehicle 2 as illustrated in FIG. 1. The gear box 1 is typically adapted to connect a rotator 30 to two input shafts (a first input shaft 13 and a second input shaft 14) of a gear shift mechanism 10 adopting a DCT (Dual Clutch Transmission) through a differential mechanism 20, and control the difference in rotation of the two shafts by the rotator 30. The gear box 1 can realize continuously variable speed by controlling a ratio of power passing through the two shafts, for example. The gear box 1 can be switched between a state as a stepped variable transmission which uses a gear position arranged at each of the two shafts and a state as a continuously variable transmission which controls differential rotation of the differential mechanism 20 by the rotator 30 to realize a gear ratio corresponding to an intermediate position between a current gear position and a next gear position, for example. As a result, the gear box 1 can realize driving close to an optimal fuel efficiency line such as that of CVT (Continuously Variable Transmission) with the DCT and increase fuel efficiency. The gear box 1 then compares efficiencies in the two states above and performs control to realize higher efficiency, thereby increasing the fuel efficiency.

The power train 3 of the vehicle 2 to which the gear box 1 is applied includes an engine 4 that generates rotary power to drive the vehicle 2, and a power transmission device (transmission) 5 that can transmit the rotary power generated by the engine 4 from the engine 4 to a driving wheel 6. The engine 4 is typically a heat engine such as an engine (internal combustion engine) that combusts fuel in a combustion chamber and converts fuel energy into mechanical work to be output as power. The engine 4 can be switched between an operating state and a non-operating state regardless of whether the vehicle 2 is at a halt or being driven. Here, the operating state of the engine 4 refers to a state of generating power to be acted upon an engine output shaft 4a, where thermal energy generated by combusting the fuel in the combustion chamber is output in the form of mechanical energy such as torque. On the other hand, the non-operating state of the engine 4 refers to a state in which the power generation is stopped, where the fuel is not combusted in the combustion chamber by cutting supply of the fuel to the combustion chamber (i.e., the fuel cut is performed) so that the mechanical energy such as the torque is not output. The power transmission device 5 includes a damper 7, the gear box 1, a differential gear 8 and the like. The power transmission device 5 is adapted to transmit the power generated by the engine 4 to the damper 7 and transmit the rotary power transmitted to the damper 7 to the gear box 1. The power transmission device 5 can use the gear box 1 to shift speed of the rotary power from the engine 4 and transmit the power to the driving wheel 6 of the vehicle 2, for example. The engine 4 and the gear box 1 are controlled by an ECU 50. Accordingly, the vehicle 2 is adapted such that, when the engine output shaft 4a of the engine 4 is rotated, the rotary power is input to the gear box 1 through the damper 7 or the like to be shifted in speed, and is transmitted to each driving wheel 6 through the differential gear 8 and the like. The vehicle 2 can then move forward or backward by the rotation of each driving wheel 6.

The gear box 1 of the present embodiment is provided on a power transmission route from the engine 4 to the driving wheel 6 and can output the rotary power transmitted from the engine 4 to the driving wheel 6 upon shifting the speed of the power. The power transmitted to the gear box 1 is shifted in speed with a predetermined gear ratio (=input rotational speed/output rotational speed) in the gear box 1 and is transmitted to each driving wheel 6. The gear box 1 includes a dual-clutch gear shift mechanism 10 formed of a first engaging device C1 and a second engaging device C2, the differential mechanism 20, the rotator 30, a power storage device 40, a third engaging device C0, and the ECU 50 as a control system.

The gear shift mechanism 10 includes an odd-numbered gear position group 11 as a first gear position group, an even-numbered gear position group 12 as a second gear position group, the first input shaft 13, the second input shaft 14, an output shaft 15, the first engaging device C1, the second engaging device C2, and the like. The gear shift mechanism 10 performs speed shift on the rotary power input from the engine 4 to the first input shaft 13 or the second input shaft 14 through the damper 7 by a gear position included in either the odd-numbered gear position group 11 or the even-numbered gear position group 12, and can output the power from the output shaft 15 toward the driving wheel 6.

The odd-numbered gear position group 11 is formed of a plurality of gear positions, each of which is assigned a predetermined gear ratio, and is in this case formed of a first gear position 61 and a third gear position 63 for forward movement as odd-numbered positions. That is, the odd-numbered gear position group 11 forms an odd-numbered gear shifting unit (first gear shift unit) 10A. The odd-numbered gear shifting unit 10A includes a reverse position 65 for backward movement as well as switchover units 66 and 67 in addition to the odd-numbered gear position group 11. The even-numbered gear position group 12 is formed of a plurality of gear positions, each of which is assigned a predetermined gear ratio, and is in this case formed of a second gear position 62 and a fourth gear position 64 for forward movement as even-numbered positions. The even-numbered gear position group 12 forms an even-numbered gear shifting unit (second gear shift unit) 10B. The even-numbered gear shifting unit 10B includes a switchover unit 68 in addition to the even-numbered gear position group 12. The gear positions in the odd-numbered gear position group 11 and the even-numbered gear position group 12 include, in descending order from the one with the largest gear ratio, the first gear position 61, the second gear position 62, the third gear position 63, and the fourth gear position 64.

The first input shaft 13 forms an input shaft of the odd-numbered gear position group 11 and is an input rotary member to which the rotary power from the engine 4 is input in the gear box 1. The second input shaft 14 forms an input shaft of the even-numbered gear position group 12 and is an input rotary member to which the rotary power from the engine 4 is input in the gear box 1. The first input shaft 13 is formed to have a columnar shape. The second input shaft 14 is formed to have a cylindrical shape, where the first input shaft 13 is inserted into the inner peripheral side of the cylinder. The first input shaft 13 and the second input shaft 14 are rotatably supported against a case or the like through a shaft bearing. The power from the engine 4 is transmitted to the first input shaft 13 and the second input shaft 14, which are rotatably supported around the center of rotation being an axis of rotation X1. The axis of rotation X1 corresponds with a center of rotation of the engine output shaft 4a of the engine 4. That is, the engine output shaft 4a, the first input shaft 13, and the second input shaft 14 are coaxially arranged about the axis of rotation X1.

The first engaging device C1 is provided at an end of the first input shaft 13 on the side of the engine 4. Another end of the first input shaft 13 on the side opposite the engine 4, namely an end opposite the first engaging device C1, is projected to be exposed from the second input shaft 14. Disposed to the first input shaft 13 are, in order from the side of the engine 4, the first engaging device C1, the differential mechanism 20, a drive gear 61a, the switchover unit 66, a drive gear 63a, the switchover unit 67, and a drive gear 65a. The differential mechanism 20, the drive gear 61a, the switchover unit 66, the drive gear 63a, the switchover unit 67, and the drive gear 65a are provided in a part of the first input shaft 13 exposed from the second input shaft 14. The second engaging device C2 is provided at an end of the second input shaft 14 on the side of the engine 4. Another end of the second input shaft 14 on the side opposite the engine 4, namely an end opposite the second engaging device C2, is connected to the differential mechanism 20 through a transmission unit 70. Disposed to the second input shaft 14 are, in order from the side of the engine 4, the second engaging device C2, a drive gear 64a, a drive gear 62a, and a gear 71.

In the gear box 1, the output shaft 15 is an output rotary member outputting the rotary power toward the driving wheel 6. The output shaft 15 is rotatably supported against a casing or the like through a shaft bearing. The power from the engine 4 is transmitted to the output shaft 15, which is rotatably supported around the center of rotation being an axis of rotation X2 that is parallel to the axis of rotation X1. The output shaft 15 functions as an output member common to the odd-numbered gear shifting unit 10A and the even-numbered gear shifting unit 10B. The output shaft 15 is connected to the driving wheel 6 to be able to transmit power thereto through a drive gear 16, a driven gear 17, the differential gear 8 and the like. The drive gear 16 and an end of the output shaft 15 on the side of the engine 4 are coupled to be able to rotate together, while a driven gear 65b and another end of the output shaft are coupled to be able to rotate together. Disposed to the output shaft 15 are, in order from the side of the engine 4, the drive gear 16, a driven gear 64b, the switchover unit 68, a driven gear 62b, a driven gear 61b, a driven gear 63b, and the driven gear 65b.

The gear positions of the odd-numbered gear position group 11 are provided such that the drive gears 61a and 63a are supported by the first input shaft 13 to be able to rotate relatively to each other through a bush or the like, and that the driven gears 61b and 63b are coupled to the output shaft 15 to be able to rotate together. The drive gear 61a and the driven gear 61b form a gear pair of the first gear position 61 in mesh with each other. The drive gear 63a and the driven gear 63b form a gear pair of the third gear position 63 in mesh with each other. Moreover, the reverse position 65 is provided such that the drive gear 65a is supported by the first input shaft 13 to be able to rotate relatively to each other through a bush or the like, and that the driven gear 65b is coupled to the output shaft 15 to be able to rotate together. The drive gear 65a and the driven gear 65b form a gear pair of the reverse position 65 in mesh with each other. The gear positions of the even-numbered gear position group 12 are provided such that the drive gears 62a and 64a are coupled to the second input shaft 14 to be able to rotate together, and that the driven gears 62b and 64b are supported by the output shaft 15 to be able to rotate relatively to each other through a bush or the like. The drive gear 62a and the driven gear 62b form a gear pair of the second gear position 62 in mesh with each other. The drive gear 64a and the driven gear 64b form a gear pair of the fourth gear position 64 in mesh with each other. Here, the gear shift mechanism 10 is provided such that the even-numbered gear shifting unit 10B is disposed on the side of the engine 4 while the odd-numbered gear shifting unit 10A is disposed on the side opposite the engine, with reference to the differential mechanism 20 that is coaxially arranged about the axis of rotation X1.

Each of the switchover units 66, 67 and 68 included in the odd-numbered gear shifting unit 10A and the even-numbered gear shifting unit 10B is configured by including a synchronous mesh mechanism or the like and switches the state of the first gear position 61, the second gear position 62, the third gear position 63, the fourth gear position 64, and the reverse position 65 between engaged/disengaged states. The switchover unit 66 selectively couples either the drive gear 61a or the drive gear 63a to the first input shaft 13. The switchover unit 67 couples the drive gear 65a to the first input shaft 13 when an engagement member is positioned on the side of the drive gear 65a. As for the odd-numbered gear shifting unit 10A, all of the drive gears 61a, 63a and 65a are disengaged from the first input shaft 13 and switched to idling states when engagement members of the switchover unit 66 and the switchover unit 67 are both at neutral positions. As a result, the odd-numbered gear shifting unit 10A can cut off the transmission of power between the first input shaft 13 and the output shaft 15. The switchover unit 68 selectively couples either the driven gear 62b or the driven gear 64b to the output shaft 15. As for the even-numbered gear shifting unit 10B, both of the driven gears 62b and 64b are disengaged from the output shaft 15 and switched to idling states when an engagement member of the switchover unit 68 is at a neutral position. As a result, the even-numbered gear shifting unit 10B can cut off the transmission of power between the second input shaft 14 and the output shaft 15.

The first engaging device C1 provided between the engine 4 and the first input shaft 13 of the odd-numbered gear position group 11 can engage/disengage the transmission of power between the engine 4 and the first input shaft 13. The first engaging device C1 can be switched between an engaged state in which the engine 4 and the first input shaft 13 are engaged to be able to transmit power therebetween, and a disengaged state in which the engagement is released to cut off the power transmission. The second engaging device C2 provided between the engine 4 and the second input shaft 14 of the even-numbered gear position group 12 can engage/disengage the transmission of power between the engine 4 and the second input shaft 14. The second engaging device C2 can be switched between an engaged state in which the engine 4 and the second input shaft 14 are engaged to be able to transmit power therebetween, and a disengaged state in which the engagement is released to cut off the power transmission. While an automatic clutch device can be used for the first engaging device C1 and the second engaging device C2, for example, an engaging device of a dog clutch type or the like may be used as well. Here, the first engaging device C1 includes an engine-side engaging member Ca connected to the engine output shaft 4a through the damper 7, the third engaging device C0 and the like, and a gear box-side engaging member C1b connected to the first input shaft 13. The second engaging device C2 includes the engine-side engaging member Ca also used by the first engaging device C1, and a gear box-side engaging member C2b connected to the second input shaft 14. The first engaging device C1 and the second engaging device C2 can be switched to the engaged state or the disengaged state by an actuator that is actuated by hydraulic pressure or the like. The first engaging device C1 and the second engaging device C2 can be controlled to be in a fully engaged state, a semi-engaged state, or the disengaged state depending on the hydraulic pressure supplied.

The differential mechanism 20 is configured to connect a rotational shaft 31 of the rotator 30, the first input shaft 13 and the second input shaft 14 to be differentially rotated. While the differential mechanism 20 of the present embodiment is described to be formed of a so-called differential gear, a planetary gear mechanism may be used as well, for example. The center of rotation of each of rotating components of the differential mechanism 20 is disposed coaxially with the axis of rotation X1, the rotating components being differentially rotated with respect to one another. Each rotating component can rotate about the center of rotation being the axis of rotation X1 when power is transmitted to the component. Here, the differential mechanism 20 includes a first sun gear 20S1, a second sun gear 20S2, and a carrier 20C as the plurality of rotating components that can be differentially rotated with respect to one another. The first sun gear 20S1 and the second sun gear 20S2 are external gears. The carrier 20C holds a plurality of pinion gears 20P to be able to rotate/revolve while in mesh with both the first sun gear 20S1 and the second sun gear 20S2.

In the differential mechanism 20 of the present embodiment, the first sun gear 20S1 is the component connected to the first input shaft 13, the second sun gear 20S2 is the component connected to the second input shaft 14, and the carrier 20C is the component connected to the rotational shaft 31. The first sun gear 20S1 is disk-shaped and connected to the first input shaft 13 to be able to rotate therewith. The second sun gear 20S2 is ring-shaped and connected to the second input shaft 14 through the transmission unit 70. The transmission unit 70 includes a gear 71, a gear 72, a chain transmission mechanism 73, and a transmission shaft 74. The gear 71 is connected to an end of the second input shaft 14 to be able to rotate therewith, the end being opposite to an end corresponding to the side of the second engaging device C2. The gear 72 is in mesh with the gear 71. The chain transmission mechanism 73 performs transmission of power mutually between the gear 72 and the transmission shaft 74 through a chain or the like. The transmission shaft 74 is connected to the second sun gear 20S2 to be able to rotate therewith. The transmission unit 70 can thus perform mutual transmission of power between the second input shaft 14 and the second sun gear 20S2. Here, the transmission unit 70 transmits power between the second input shaft 14 and the second sun gear 20S2 by reversing the direction of rotation about the axis of rotation X1. The carrier 20C has a shape of an annular disk and supports the pinion gear 20P being the external gear against a pinion shaft such that the pinion gear can rotate and revolve. The carrier 20C is connected to the rotational shaft 31 of the rotator 30 through a gear 32, a gear 33 and the like. The gear 32 is connected to the carrier 20C to be able to rotate therewith. The gear 33 is connected to the rotational shaft 31 to be able to rotate therewith and is in mesh with the gear 32.

The rotator 30 is a rotary electrical machine including a function as a motor (electric motor) and a function as a generator. The rotator 30 includes a powering function which converts electrical power supplied from the power storage device 40 such as a battery through an inverter or the like into mechanical power, and a regeneration function which converts the input mechanical power into electrical power and charges the power into the power storage device 40 through the inverter or the like. The electrical power generated by the rotator 30 can be charged into the power storage device 40. An AC synchronous motor generator can be used as the rotator 30, for example. The power storage device 40 can charge the electrical power generated by the rotator 30. The rotator 30 in powering consumes the electrical power and outputs torque, by which the rotational shaft 31 can be rotationally driven. The rotator 30 in regeneration is rotationally driven by the torque transmitted to the rotational shaft 31 and generates electrical power to be able to cause a load torque (reaction torque) corresponding to the load of generation to be acted upon the rotational shaft 31.

The third engaging device C0 is provided between the engine 4 and each of the first engaging device C1 and the second engaging device C2, and can engage/disengage the transmission of power between the engine 4 and each of the first engaging device C1 and the second engaging device C2. Here, the third engaging device C0 is provided between the engine 4 and the damper 7. That is, the power transmission device 5 of the present embodiment includes the third engaging device C0, the damper 7, the first engaging device C1, and the second engaging device C2 disposed in this order from the side of the engine 4 with respect to the power transmission route. The third engaging device C0 can be switched between an engaged state in which the engine output shaft 4a of the engine 4 and a damper input shaft 7a of the damper 7 are engaged to be able to transmit power therebetween, and a disengaged state in which the engagement is released to cut off the power transmission. As a result, the third engaging device C0 can transmit power between the engine 4 and each of the first engaging device C1 and the second engaging device C2 in the engaged state and cut off the transmission of power between the engine 4 and each of the first engaging device C1 and the second engaging device C2 in the disengaged state. While an automatic clutch device can be used for the third engaging device C0, for example, an engaging device of a dog clutch type or the like may be used as well. Here, the third engaging device C0 includes an engine-side engaging member C0a connected to the engine output shaft 4a, and a damper-side engaging member C0b connected to the damper input shaft 7a. The third engaging device C0 can be switched to the engaged state or the disengaged state by an actuator that is actuated by hydraulic pressure or the like. The third engaging device C0 can be controlled to be in a fully engaged state, a semi-engaged state, or the disengaged state depending on the hydraulic pressure supplied.

The ECU 50 controls driving of each unit in the vehicle 2 and includes an electronic circuit which is predominantly formed of a known microcomputer including a CPU, a ROM, a RAM, and an interface. Various sensors and detectors are electrically connected to the ECU 50, to which an electrical signal corresponding to a detection result is input. The ECU 50 is also connected electrically to each unit in the vehicle 2 such as the engine 4, an actuator actuating the first engaging device C1, the second engaging device C2, the third engaging device C0 and the switchover units 66, 67, and 68 of the gear box 1, the rotator 30, and the power storage device 40. The ECU 50 executes a stored control program on the basis of various input signals and various maps input from the various sensors and detectors, outputs a drive signal to each unit in the vehicle 2, and controls driving of each unit.

The gear box 1 of the present embodiment includes, as the various sensors and detectors, a vehicle state detection device 51 that detects a state of the vehicle 2 equipped with the gear box 1, for example. The vehicle state detection device 51 may include at least one of a vehicle speed sensor, an accelerator position sensor, a throttle position sensor, an engine speed sensor, a first input shaft rotational speed sensor, a second input shaft rotational speed sensor, an output shaft rotational speed sensor, a rotational shaft rotational speed sensor, and a charge state detector, for example, but may include another sensor or detector as well. The vehicle speed sensor detects the speed of the vehicle 2. The accelerator position sensor detects an accelerator position corresponding to an amount of operation (accelerator operation amount or acceleration request operation amount) input by a driver to an accelerator pedal of the vehicle 2. The throttle position sensor detects a throttle position of the vehicle 2. The engine speed sensor detects the engine speed being the rotational speed of the engine output shaft 4a of the engine 4. The first input shaft rotational speed sensor detects the rotational speed of the first input shaft 13 (hereinafter referred to as a “first input shaft rotational speed” in some cases) of the gear box 1. The second input shaft rotational speed sensor detects the rotational speed of the second input shaft 14 (hereinafter referred to as a “second input shaft rotational speed” in some cases) of the gear box 1. The output shaft rotational speed sensor detects the rotational speed of the output shaft 15 (hereinafter referred to as an “output shaft rotational speed” in some cases) of the gear box 1. The rotational shaft rotational speed sensor detects the rotational speed of the rotational shaft 31 (hereinafter referred to as a “rotator speed” in some cases) of the rotator 30. The charge state detector detects a state of charge (SOC) corresponding to an amount of charge (charged amount) in the power storage device 40. A higher state of charge. SOC indicates a larger amount of charge in the power storage device 40.

The ECU 50 controls a throttle device of the engine 4 on the basis of the accelerator position and the vehicle speed, for example, adjusts the throttle position of an intake passage, adjusts the amount of air intake, controls the amount of fuel injection according to the change after the adjustments, adjusts the amount of air-fuel mixture filling the combustion chamber, and controls output of the engine 4. Moreover, the ECU 50 controls an actuator of a hydraulic control system or the like on the basis of the accelerator position and the vehicle speed, for example, and controls the gear position (gear ratio) of the gear box 1.

Then, the ECU 50 of the present embodiment controls the first engaging device C1, the second engaging device C2 and the rotator 30 to be able to switch the state of the gear box 1 between a stepped transmission state and a continuously variable transmission state. The ECU 50 controls the first engaging device C1, the second engaging device C2 and the rotator 30 to form a plurality of different routes (four routes in this case) as power transmission routes in the gear box 1, and realizes the stepped transmission state and the continuously variable transmission state by using the routes accordingly.

Here, the stepped transmission state of the gear box 1 refers to a state in which the rotary power from the engine 4 is shifted in speed by any gear position included in either the odd-numbered gear position group 11 or the even-numbered gear position group 12 to be output from the output shaft 15. That is, the stepped transmission state of the gear box 1 refers to a state of shifting in speed the rotary power from the engine 4 through either the first input shaft 13 or the second input shaft 14.

Furthermore, the stepped transmission state of the gear box 1 refers to a state in which the power from the engine 4 is transmitted toward the driving wheel 6 through a first route R1 or a second route R2 (to be described) as illustrated in FIG. 2 upon setting the third engaging device C0 to be in the engaged state, typically. The first route R1 is a power transmission route formed when the switchover unit 66 switches either the first gear position 61 or the third gear position 63 to a fastened state (state in which power is transmitted) while the first engaging device C1 is in the engaged state, the second engaging device C2 is in the disengaged state, and the switchover units 67 and 68 are at neutral positions. That is, the first route R1 is a route for transmitting power toward the driving wheel 6 from at least the engine 4 through the first engaging device C1, the first input shaft 13, any gear position included in the odd-numbered gear position group 11 (the first gear position 61 and the third gear position 63), and the output shaft 15 in this order. The second route R2 is a power transmission route formed when the switchover unit 68 switches either the second gear position 62 or the fourth gear position 64 to a fastened state (state in which power is transmitted) while the first engaging device C1 is in the disengaged state, the second engaging device C2 is in the engaged state, and the switchover units 66 and 67 are at neutral positions. That is, the second route R2 is a route for transmitting power toward the driving wheel 6 from at least the engine 4 through the second engaging device C2, the second input shaft 14, any gear position included in the even-numbered gear position group 12 (the second gear position 62 and the fourth gear position 64), and the output shaft 15 in this order. Note that in this case, the power from the engine 4 is transmitted to the first engaging device C1 or the second engaging device C2 through the third engaging device C0, the damper 7 and the like.

When the gear box 1 is in the stepped transmission state, the ECU 50 calculates a target output on the basis of the accelerator position detected by the accelerator position sensor (or the throttle position detected by the throttle position sensor) and the vehicle speed detected by the vehicle speed sensor, for example, and calculates a target control amount such as target engine torque and target engine speed with which the target output is realized with the highest fuel efficiency. The ECU 50 then controls output from the engine 4 by controlling a fuel injection timing of a fuel injection valve and an ignition timing of a spark plug of the engine 4 as well as the throttle position of a throttle device, and controls output of the engine 4 such that the torque of the engine 4 equals the target engine torque and the engine speed equals the target engine speed. Moreover, when the gear box 1 is in the stepped transmission state, the ECU 50 may control the gear position by controlling each unit of the gear box 1 on the basis of the accelerator position detected by the accelerator position sensor and the vehicle speed detected by the vehicle speed sensor, for example. In this case, the ECU 50 performs gear shift control on the gear box 1 on the basis of a gear shift map on which a plurality of gear shift lines is specified according to the accelerator position and the vehicle speed, for example.

Referring back to FIG. 1, the continuously variable transmission state of the gear box 1 refers to a state in which the rotary power from the engine 4 is shifted in speed with an intermediate gear ratio of the gear ratios of the gear positions included in the odd-numbered gear position group 11 and the even-numbered gear position group 12 to be output from the output shaft 15, and in which the gear ratio can be varied continuously. That is, the gear box 1 in the continuously variable transmission state can realize the gear ratio corresponding to an intermediate position of the positions included in at least the odd-numbered gear position group 11 and the even-numbered gear position group 12. The continuously variable transmission state of the gear box 1 in this case refers to a state in which the rotary power from the engine 4 is shifted in speed through the first input shaft 13, the second input shaft 14, and the differential mechanism 20, where the ECU 50 realizes the continuously variable transmission state of the gear box 1 by rotationally controlling the rotator 30 and adjusting the differential rotation of the differential mechanism 20.

Furthermore, the continuously variable transmission state of the gear box 1 refers to a state in which the power from the engine 4 is transmitted toward the driving wheel 6 through a third route R3 or a fourth route R4 (to be described) as illustrated in FIG. 2 upon setting the third engaging device C0 to be in the engaged state, typically. The third route R3 is a power transmission route formed when the switchover unit 68 switches either the second gear position 62 or the fourth gear position 64 to a fastened state (state in which power is transmitted) while the first engaging device C1 is in the engaged state, the second engaging device C2 is in the disengaged state, and the switchover units 66 and 67 are at neutral positions. That is, the third route R3 is a route provided for transmitting power toward the driving wheel 6 from at least the engine 4 through the first engaging device C1, the first input shaft 13, the differential mechanism 20, the transmission unit 70, the second input shaft 14, any gear position included in the even-numbered gear position group 12 (the second gear position 62 and the fourth gear position 64), and the output shaft 15 in this order. The fourth route R4 is a power transmission route formed when the switchover unit 66 switches either the first gear position 61 or the third gear position 63 to a fastened state (state in which power is transmitted) while the first engaging device C1 is in the disengaged state, the second engaging device C2 is in the engaged state, and the switchover units 67 and 68 are at neutral positions. That is, the fourth route R4 is a route provided for transmitting power toward the driving wheel 6 from at least the engine 4 through the second engaging device C2, the second input shaft 14, the transmission unit 70, the differential mechanism 20, the first input shaft 13, any gear position included in the odd-numbered gear position group 11 (the first gear position 61 and the third gear position 63), and the output shaft 15 in this order. The ECU 50 can then change the gear ratio of the gear box 1 continuously by rotationally controlling the rotator 30 and adjusting the differential rotation of the differential mechanism 20 while in the state the gear box 1 transmits the power from the engine 4 toward the driving wheel 6 through the third route R3 or the fourth route R4. The ECU 50 typically changes the gear ratio in the continuously variable transmission state by controlling the amount of power generated by the rotator 30 when the gear box 1 is in the continuously variable transmission state. Note that in this case as well, the power from the engine 4 is transmitted to the first engaging device C1 or the second engaging device C2 through the third engaging device C0, the damper 7 and the like. The change in gear ratio when the gear box 1 is in the continuously variable transmission state will be described in detail later on.

When the gear box 1 is in the continuously variable transmission state, the ECU 50 can operate the engine 4 on an optimal fuel efficiency line, for example, and can thus increase the fuel efficiency. The optimal fuel efficiency line is a set of operating points of the engine 4 at which the engine 4 can be operated with the optimal fuel efficiency (efficiently). Here, the operating point of the engine 4 is determined according to engine torque and engine speed output by the engine 4. The optimal fuel efficiency line represents the relationship between the engine torque and the engine speed with which the engine 4 can be operated with the best fuel efficiency, or the best engine efficiency. The fuel efficiency in this case refers to fuel consumption per unit work and corresponds to an amount of fuel required for the vehicle 2 to travel a unit distance or a distance the vehicle 2 can travel with a unit fuel amount. That is, the optimal fuel efficiency line is set on the basis of the engine speed and the engine torque with which the engine 4 can be operated while giving priority to the distance that can be traveled by the vehicle 2 equipped with the engine 4 with the unit fuel amount, and is determined beforehand according to an output characteristic of the engine 4. When the gear box 1 is in the continuously variable transmission state, the ECU 50 typically controls output of the engine 4 such that the operating point of the engine 4 is positioned on the optimal fuel efficiency line of the engine 4.

When the gear box 1 is in the continuously variable transmission state, the ECU 50 basically performs control which calculates target engine speed and target engine torque from the optimal fuel efficiency line and the target output that is calculated on the basis of the accelerator position detected by the accelerator position sensor (or the throttle position detected by the throttle position sensor) and the vehicle speed detected by the vehicle speed sensor, for example. The ECU 50 calculates the target engine speed and the target engine torque by finding a point of intersection (operating point) of an equal output line corresponding to the target output and the optimal fuel efficiency line, for example. The ECU 50 then controls output of the engine 4 such that the engine torque and the engine speed of the engine 4 equal the target engine torque and the target engine speed, respectively, as well as controls the gear ratio by controlling each unit of the gear box 1 (amount of power generated by the rotator 30 in this case) according to the rotational speed of the output shaft 15 (in other words, the vehicle speed).

The ECU 50 of the present embodiment can switch the state of the gear box 1 between the stepped transmission state and the continuously variable transmission state as described below, for example.

The ECU 50 for example performs control as follows when shifting the state from the stepped transmission state in which the rotary power from the engine 4 is shifted in speed by any gear position included in the odd-numbered gear position group 11, namely the state in which the power is transmitted along the first route R1 (refer to FIG. 2), to the continuously variable transmission state while setting the first engaging device C1 to be in the engaged state and the second engaging device C2 to be in the disengaged state.

In this case, the ECU 50 first controls the rotator 30 to synchronize the rotational speed of the second input shaft 14 (second input shaft rotational speed) with rotational speed corresponding to the current rotational speed of the output shaft 15 (output shaft rotational speed). Here, the ECU 50 controls the rotational speed of the rotational shaft 31 of the rotator 30 such that the rotational speed of the driven gear 62b of the second gear position 62 or the driven gear 64b of the fourth gear position 64 of the second input shaft 14 is synchronized with and roughly equals the rotational speed of the output shaft 15. After synchronizing the rotational speeds, the ECU 50 shifts the state of the gear box to a state in which the rotary power from the engine 4 through the differential mechanism 20 is shifted in speed by any gear position included in the even-numbered gear position group 12. In this case, the ECU 50 performs control such that the switchover unit 68 switches either the second gear position 62 or the fourth gear position 64 (the gear position, the rotation of which is synchronized in the aforementioned synchronization control) to a fastened state and sets the switchover unit 66 at a neutral position while keeping the first engaging device C1 in the engaged state and the second engaging device C2 in the disengaged state. In other words, the ECU 50 shifts the state of the gear box 1 to the state in which power is transmitted along the third route R3 (refer to FIG. 2). The ECU 50 then realizes the continuously variable transmission state by controlling the rotator 30 and changing the gear ratio. When shifting the state from the continuously variable transmission state to the stepped transmission state in which the rotary power from the engine 4 is shifted in speed by any gear position included in the even-numbered gear position group 12, the ECU 50 sets the second engaging device C2 to be in the engaged state and the first engaging device C1 to be in the disengaged state, and shifts the state of the gear box 1 to the state in which power is transmitted along the second route R2 (refer to FIG. 2), thereby ending the control of the rotator 30.

Moreover, the ECU 50 for example performs control as follows when shifting the state from the stepped transmission state in which the rotary power from the engine 4 is shifted in speed by any gear position included in the even-numbered gear position group 12, namely the state in which the power is transmitted along the second route R2 (refer to FIG. 2), to the continuously variable transmission state while setting the first engaging device C1 to be in the disengaged state and the second engaging device C2 to be in the engaged state.

In this case, the ECU 50 first controls the rotator 30 to synchronize the rotational speed of the first input shaft 13 (first input shaft rotational speed) with rotational speed corresponding to the current rotational speed of the output shaft 15 (output shaft rotational speed). Here, the ECU 50 controls the rotational speed of the rotational shaft 31 of the rotator 30 such that the rotational speed of the first input shaft 13 is synchronized with and roughly equals the rotational speed of the drive gear 61a of the first gear position 61 or the drive gear 63a of the third gear position 63 corresponding to the rotational speed of the output shaft 15. After synchronizing the rotational speeds, the ECU 50 shifts the state of the gear box to a state in which the rotary power from the engine 4 through the differential mechanism 20 is shifted in speed by any gear position included in the odd-numbered gear position group 11. In this case, the ECU 50 performs control such that the switchover unit 66 switches either the first gear position 61 or the third gear position 63 (the gear position, the rotation of which is synchronized in the aforementioned synchronization control) to a fastened state and sets the switchover unit 68 at a neutral position while keeping the first engaging device C1 in the disengaged state and the second engaging device C2 in the engaged state. In other words, the ECU 50 shifts the state of the gear box 1 to the state in which power is transmitted along the fourth route (refer to FIG. 2). The ECU 50 then realizes the continuously variable transmission state by controlling the rotator 30 and changing the gear ratio. When shifting the state from the continuously variable transmission state to the stepped transmission state in which the rotary power from the engine 4 is shifted in speed by any gear included in the odd-numbered gear position group 11, the ECU 50 sets the first engaging device C1 to be in the engaged state and the second engaging device C2 to be in the disengaged state, and shifts the state of the gear box 1 to the state in which power is transmitted along the first route R1 (refer to FIG. 2), thereby ending the control of the rotator 30.

Now, a specific example will be used to describe the switching of the gear box 1 from the stepped transmission state to the continuously variable transmission state as well as the changing of the gear ratio in the continuously variable transmission state. There will be described an example where the rotator 30 is used to transition the gear from the first gear position 61 to the second gear position 62 through an intermediate position in the continuously variable transmission state. In order to facilitate understanding, there will be described a case where, for example, the differential mechanism 20 has a gear ratio ρ=1, the first gear position 61 has a gear ratio G1=4, the second gear position 62 has a gear ratio G2=2, the engine speed equals Ne=1000 rpm, and only the rotational direction but the rotational speed changes in the transmission unit 70. Note that the gear ratio ρ can be expressed as “ρ=Zs1/Zs2” when “Zs1” is the number of teeth in the first sun gear 20S1 and “Zs2” is the number of teeth in the second sun gear 20S2.

The power from the engine 4 is transmitted to the output shaft 15 through the first engaging device C1, the first input shaft 13, and the first gear position 61 when the gear box 1 is in the stepped transmission state with the first gear position 61 being selected. At this time, rotational speed Nin1 (S1) of the first input shaft 13 and the first sun gear 20S1 corresponds with engine speed Ne and equals Nin1 (s1)=1000 rpm. Rotational speed Nout of the output shaft 15 equals Nout=1000/4=250 rpm. On the other hand, rotational speed Ns2 of the second sun gear 20S2 equals Nin2=1000 rpm. Rotational speed N2i of the driven gear 62b of the second gear position 62 in an idle state (such speed is hereinafter referred to as “idler speed” in some cases) equals N2i=1000/2=500 rpm.

When transitioning the states from the stepped transmission state to the continuously variable transmission state, the ECU 50 performs rotational control on the rotator 30 and controls such that the rotational speed N2i of the driven gear 62b is synchronized with and roughly equals the rotational speed Nout of the output shaft 15, as described above. That is, the ECU 50 performs rotational control on the rotator 30 to set the rotational speed Nc of the carrier 20C to 250 rpm and the rotational speed Ns2 of the second sun gear 20S2 to 500 rpm. The ECU 50 thus decreases the rotational speed N2i of the driven gear 62b down to 250 rpm to be synchronized with the rotational speed Nout of the output shaft 15. While keeping the first engaging device C1 in the engaged state and the second engaging device C2 in the disengaged state, the ECU 50 performs control to switch the second gear position 62 to a fastened state by the switchover unit 68, set the switchover unit 66 at a neutral position, and shift to the continuously variable transmission state.

When changing the gear ratio in the continuously variable transmission state, the ECU 50 adjusts the amount of power generated by the rotator 30 and adjusts the load torque acted upon the rotational shaft 31 according to the power generation load, thereby adjusting the rotational speed Nc of the carrier 20C with the reaction force. The ECU 50 can thus change the gear ratio in the gear box 1 continuously by adjusting the rotational speed Ns2 of the second sun gear 20S2 and the rotational speed Nout of the output shaft 15. In this case, the vehicle speed increases with the increase in the rotational speed Ns2 of the second sun gear 20S2, for example. The amount of power generated by the rotator 30 in the continuously variable transmission state corresponds to a value obtained by multiplying differential rotational speed ΔNc between the rotational speeds Nc of the carrier 20C before and after the synchronization control by the torque of the carrier 20C.

The ECU 50 then increases the amount of power generated by the rotator 30 and decreases the rotational speed Nc of the carrier 20C down to zero, thereby shifting to a gear state equivalent to where the second gear position 62 is selected in the stepped transmission state. The ECU 50 in this state switches the second engaging device C2 to be in the engaged state and the first engaging device C1 to be in the disengaged state to shift the state of the gear box 1 to the one where the second gear position 62 is actually selected in the stepped transmission state. This causes the torque transmitted to the rotational shaft 31 to be decreased, so that the ECU 50 performs control to end the power generation in the rotator 30 and completes transition to the second gear position 62.

The ECU 50 may perform control as described above when upshifting in a typical case and, when downshifting, perform downshift in the stepped transmission state while using various methods as with a general stepped variable transmission.

The ECU 50 can control the gear box 1 to be switched to the stepped transmission state and the continuously variable transmission state as described above. Moreover, the ECU 50 of the present embodiment can drive the vehicle 2 in various driving modes such as an engine driving mode, an HV driving mode, an EV driving mode, and a regenerative driving mode by controlling the engine 4, the first engaging device C1, the second engaging device C2, the third engaging device C0, and the rotator 30 in concert with one another and using or selectively using the engine 4 and the rotator 30 as a motor. The ECU 50 can increase the fuel efficiency as a result.

Here, the engine driving mode is a driving mode in which the vehicle 2 is driven not by the power of the rotator 30 but by the power of the engine 4, for example. The ECU 50 can realize the engine driving mode by performing output control on the engine 4 upon setting the third engaging device C0 to be in the engaged state. In this case, the ECU 50 sets the output of the rotator 30 to zero. The ECU 50 also sets the gear box 1 to be in the stepped transmission state or the continuously variable transmission state so that the gear box 1 shifts in speed the power output from the engine 4 with a predetermined gear ratio and transmits the power to the driving wheel 6.

The HV driving mode is a driving mode in which the vehicle 2 is driven by the power of the engine 4 and the power of the rotator 30. Similar to the engine driving mode, the ECU 50 can realize the HV driving mode by performing output control on the engine 4 upon setting the third engaging device C0 to be in the engaged state and further performing output control on the rotator 30.

The EV driving mode is a driving mode in which the vehicle 2 is driven not by the power of the engine 4 but by the power of the rotator 30. That is, the EV driving mode is an MG drive mode according to the rotator 30. The ECU 50 can realize the EV driving mode by performing output control on the rotator 30 upon setting the third engaging device C0 to be in the disengaged state. In this case, the ECU 50 sets the output of the engine 4 to zero to be in a non-operating state. That is, the ECU 50 of the present embodiment can perform control that drives the vehicle 2 by the rotary power output from the rotator 30 by controlling the third engaging device C0 and the rotator 30 and setting the third engaging device C0 to be in the disengaged state, whereby the EV driving mode can be realized. In the EV driving mode, the ECU 50 can separate the engine 4 from the power transmission device 5 constructing a drive system of the vehicle 2 by setting the third engaging device C0 to be in the disengaged state. As a result, the gear box 1 can have a reduced friction loss of the engine 4.

When setting the third engaging device C0 to be in the disengaged state and driving the vehicle 2 by the rotary power output from the rotator 30 as in the EV driving mode, the ECU 50 controls the first engaging device C1 and the second engaging device C2 to be in the engaged states. The gear box 1 can thus be adapted such that the first input shaft 13 and the second input shaft 14 are rotated not differentially but integrally, and the rotary power from the rotator 30 is shifted in speed by any gear position included in either the odd-numbered gear position group 11 or the even-numbered gear position group 12 to be output from the output shaft 15 and transmitted to the driving wheel 6. Moreover, the ECU 50 can generate power in the rotator 30 by using the power generated in the engine 4 by setting the third engaging device C0 to be in the engaged state while the first engaging device C1 and the second engaging device C2 are in the engaged states.

The regenerative driving mode is a driving mode in which regenerative braking is performed by the rotator 30 when the vehicle 2 is decelerated. The ECU 50 can realize the regenerative driving mode by performing power generation control on the rotator 30 when the vehicle 2 is decelerated. That is, the ECU 50 controls the rotator 30 when the vehicle 2 is decelerated to be able to perform control that generates power in the rotator 30 by using the rotary power transmitted thereto and stores the power in the power storage device 40, thereby realizing the regenerative driving mode, the rotary power being transmitted from the side of the driving wheel 6 of the vehicle 2 to the rotator 30 through the differential gear 8, the driven gear 17, the drive gear 16, the output shaft 15, any gear position included in the odd-numbered gear position group 11 or the even-numbered gear position group 12, the differential mechanism 20, the gear 32, the gear 33, and the rotational shaft 31. In this case, the ECU 50 may set the third engaging device C0 to be in either the engaged state or the disengaged state, where the third engaging device C0 is set to be in the disengaged state when required braking force can be satisfied by only the regenerative braking force of the rotator 30, for example. On the other hand, the ECU 50 may set the third engaging device C0 to be in the engaged state and use an engine brake of the engine 4 when the regenerative braking force alone of the rotator 30 cannot satisfy the required braking force.

Then, the ECU 50 of the present embodiment typically controls the engine 4 and the rotator 30 on the basis of the charged state of the power storage device 40 and the driving state of the vehicle 2 and switches the vehicle to the various driving modes.

When the state of charge (SOC) of the power storage device 40 is relatively high, the ECU 50 can for example perform control that decreases output of the engine 4 relatively to a case where the state of charge of the power storage device 40 is relatively low, and drives the vehicle 2 by the rotary power output from the rotator 30. Typically, the ECU 50 performs control to relatively decrease the output of the engine 4 and drive the vehicle 2 by the rotary power output from the rotator 30, when the state of charge of the power storage device 40 is higher than or equal to a preset allowable upper limit value. The allowable upper limit value being an upper threshold set to the state of charge of the power storage device 40 may be set in advance on the basis of an actual vehicle evaluation or the like, and is set on the basis of the charge capacity of the power storage device 40, for example. In this case, the ECU 50 may drive the vehicle 2 in the HV driving mode by relatively decreasing the output of the engine 4 and assisting the engine by the rotary power output from the rotator 30, or may drive the vehicle 2 in the EV driving mode by setting the output of the engine 4 to zero to be in the non-operating state and performing output control on the rotator 30. As a result, the ECU 50 can optimally perform powering of the rotator 30 on the basis of the state of charge of the power storage device 40, so that surplus power stored in the power storage device 40 is used to perform powering of the rotator 30 to be able to efficiently process the surplus power, for example. The gear box 1 can increase the fuel efficiency as a result.

The ECU 50 may perform the aforementioned control that drives the vehicle 2 by the rotary power output from the rotator 30 in an area of operation where the efficiency of the engine 4 is relatively poor, for example. The ECU 50 can perform the control that drives the vehicle 2 with the rotary power output from the rotator 30 in the EV driving mode and the HV driving mode, when the vehicle 2 is driven steadily, for example. The ECU 50 can thus drive the vehicle 2 with the rotary power output from the rotator 30 when the vehicle 2 is driven steadily and when a low load is imposed on the engine 4, the efficiency of which at this time tends to be relatively decreased in the engine driving mode, for example. The gear box 1 can further increase the fuel efficiency as a result.

In this case, the ECU 50 may determine that the vehicle 2 is in a steady driving state when an amount of change in a parameter indicating the driving state of the vehicle 2 is smaller than a preset steadiness determining reference value. The throttle position detected by the throttle position sensor included in the vehicle state detection device 51 and the accelerator position detected by the accelerator position sensor can be used as the parameter indicating the driving state of the vehicle 2. The ECU 50 can determine that the vehicle is substantially in the steady driving state with a small change in the throttle position when the amount of change per unit time of the throttle position is smaller than the steadiness determining reference value, for example. Here, the steadiness determining reference value is a threshold set for the amount of change in the parameter (such as the throttle position and accelerator position) indicating the driving state of the vehicle 2 to determine the steady driving state thereof, and may be set in advance on the basis of the actual vehicle evaluation or the like.

The ECU 50 may vary the steadiness determining reference value used to determine the steady driving state of the vehicle 2 on the basis of the state of charge of the power storage device 40. In this case, the ECU 50 relatively increases the steadiness determining reference value when the state of charge of the power storage device 40 is relatively high, and relatively decreases the steadiness determining reference value when the state of charge of the power storage device 40 is relatively low. The ECU 50 can relatively expand a region in which the vehicle 2 is determined to be in the steady driving state by relatively increasing the steadiness determining reference value when the state of charge of the power storage device 40 is relatively high, and can thus relatively expand a region in which the vehicle 2 is driven by the rotary power output from the rotator 30 in the EV driving mode and the HV driving mode. As a result, the ECU 50 can drive the vehicle 2 proactively by the rotary power output from the rotator 30 when the state of charge of the power storage device 40 is relatively high, so that the vehicle 2 can be driven by using the surplus power stored in the power storage device 40 and that the surplus power can be processed efficiently. On the other hand, the ECU 50 can relatively narrow the region in which the vehicle 2 is determined to be in the steady driving state by relatively decreasing the steadiness determining reference value when the state of charge of the power storage device 40 is relatively low, and can thus relatively narrow a region in which the vehicle 2 is driven by the rotary power output from the rotator 30 in the EV driving mode and the HV driving mode. As a result, the ECU 50 can prevent the vehicle 2 from being in a mode in which the vehicle is driven by the rotary power output from the rotator 30 when the state of charge of the power storage device 40 is relatively low, so that the power charged in the power storage device 40 can be saved.

Moreover, the ECU 50 controls the engine 4 and the rotator 30 on the basis of the charged state of the power storage device 40 to be able to perform control that relatively decreases the amount of power generated by the rotator 30 when the state of charge of the power storage device 40 is relatively high, and relatively increases the amount of power generated by the rotator 30 when the state of charge of the power storage device 40 is relatively low.

Here, the gear box 1 of the present embodiment is adapted to generate power by the rotator 30 not only in the regenerative driving mode but in the continuously variable transmission state and store the power generated by the rotator 30 into the power storage device 40. The ECU 50 of the present embodiment is configured to change the amount of power generated by the rotator 30 on the basis of the state of charge of the power storage device 40 by changing the area of operation in which the gear box 1 is set to be in the continuously variable transmission state on the basis of the state of charge of the power storage device 40.

The ECU 50 of the present embodiment switches the state of the gear box 1 between the stepped transmission state and the continuously variable transmission state on the basis of an operating characteristic map (or a mathematical model equivalent thereto) as illustrated in FIG. 3, for example. FIG. 3 is a diagram illustrating an example of the operating characteristic of the engine 4 of the power train 3, where a horizontal axis and a vertical axis of the diagram represent the engine speed and the engine torque, respectively. A solid line L21 in FIG. 3 represents the aforementioned optimal fuel efficiency line. Solid lines L22 to L30 represent fuel efficiency contours (such as a specific fuel consumption contour curve). Each of the fuel efficiency contours L22 to L30 is a set of operating points of the engine 4, the operating points having equal fuel efficiency (such as specific fuel consumption) of the engine 4. The fuel efficiency for each of the fuel efficiency contours L22 to L30 is set at a 5% interval in this example, where an area enclosed with the fuel efficiency contour L22 has the highest fuel efficiency. Dotted lines L31 to L34 represent equal output (power) lines. Each of the equal output lines L31 to L34 is a set of operating points of the engine 4, the operating points having equal output of the engine 4. A dotted line L35 in FIG. 3 represents an example of transition of the operating points of the engine 4 when the gear box 1 performs speed shift in the stepped transmission state alone. Note that the fuel efficiency contours L22 to L30 and the equal output lines L31 to L34 are illustrated as an example, where there may be provided a plurality of more fuel efficiency contours and equal output lines, or each of the fuel efficiency contours and each of the equal output lines may be interpolated as appropriate by control performed as follows. The operating characteristic map illustrated in FIG. 3 is prepared beforehand in accordance with the actual vehicle evaluation and stored in a storage unit, for example.

The ECU 50 controls the engine 4 and the rotator 30 on the basis of optimal fuel efficiency areas TA, TB, and TC illustrated in FIG. 3 to control power generation of the rotator 30, for example. When controlling the engine 4 and the rotator 30 to generate power in the rotator 30 by the power generated by the engine 4, the ECU 50 can control output of the engine 4 such that the operating point of the engine 4 is positioned within the optimal fuel efficiency areas TA, TB, and TC of the engine 4 set according to the state of charge of the power storage device 40 while allowing for the amount of power generated by the rotator 30. The three optimal fuel efficiency areas TA, TB, and TC preset according to the state of charge of the power storage device 40 may also be divided into more areas. Each of the optimal fuel efficiency areas TA, TB, and TC contains the optimal fuel efficiency line L21 and corresponds to an area with high engine speed and low engine torque with respect to the optimal fuel efficiency line L21, where a decrease in the fuel efficiency of the engine 4 is set to occur in an area within a predetermined range. The optimal fuel efficiency area TA is an area applied when the state of charge of the power storage device 40 is not sufficient while the amount of power required to be generated is relatively large. The optimal fuel efficiency area TC is an area applied when the state of charge of the power storage device 40 is excessive while the amount of power required to be generated is relatively small. The optimal fuel efficiency area TB is an area applied when the state of charge of the power storage device 40 is adequate while the amount of power required to be generated falls approximately in the middle of that for the optimal fuel efficiency area TA and the optimal fuel efficiency area TC. Among the optimal fuel efficiency areas TA, TB, and TC, the optimal fuel efficiency area TA is the smallest while the optimal fuel efficiency area TB and the optimal fuel efficiency area TC get larger in this order toward higher engine speed and lower engine torque. The relationship with the state of charge of the power storage device 40 is preset in accordance with the actual vehicle evaluation for each of the optimal fuel efficiency areas TA, TB, and TC, which are then stored in the storage unit in the form of the operating characteristic map in FIG. 3 (or the mathematical model equivalent thereto).

There will be described an example where the vehicle 2 starts moving and accelerates while the first gear position (1st) 61 is selected in the stepped transmission state.

The ECU 50 for example uses various known methods to detect current engine speed and engine torque on the basis of a result detected by the engine speed sensor and the throttle position sensor, and specifies an operating point A on the basis of the current engine speed and engine torque. When the vehicle 2 speeds up in the stepped transmission state, for example, the operating point A goes out of the optimal fuel efficiency area TA first, the optimal fuel efficiency area TB next, and lastly the optimal fuel efficiency area TC.

Here, the ECU 50 monitors the state of charge (SOC) of the power storage device 40 on the basis of the result detected by the charge state detector and selects any of the optimal fuel efficiency areas TA, TB, and TC according to the amount of the state of charge. The ECU 50 selects the optimal fuel efficiency area TA when determining on the basis of a preset state-of-charge determination value that the state of charge of the power storage device 40 is insufficient, selects the optimal fuel efficiency area TB when determining that the state of charge is adequate, and selects the optimal fuel efficiency area TC when determining that the state of charge is excessive.

The ECU 50 shifts the state of the gear box 1 to the continuously variable transmission state when the operating point A goes out of the optimal fuel efficiency area TA while the optimal fuel efficiency area TC is selected with the excessive state of charge of the power storage device 40. In this case, as illustrated in FIG. 3, the ECU 50 specifies an operating point B (engine speed and engine torque) corresponding to a point of intersection of an equal output line (equal output line between the equal output lines L33 and L34 or an interpolated value thereof) passing through the operating point A and the optimal fuel efficiency line L21, controls output of the engine 4 on the basis of the operating point B, and controls the gear ratio of the gear box 1, or the amount of power generated by the rotator 30. As a result, the ECU 50 can perform control not to cause the gear box 1 to be easily shifted to the continuously variable transmission state when the state of charge of the power storage device 40 is excessive, and can thus control the amount of power generated by the rotator 30 to keep the surplus power in the power storage device 40 from increasing.

Likewise, the ECU 50 shifts the state of the gear box 1 to the continuously variable transmission state when the operating point A goes out of the optimal fuel efficiency area TA while the optimal fuel efficiency area TA is selected with the insufficient state of charge of the power storage device 40. As a result, the ECU 50 can perform control to cause the gear box 1 to be shifted to the continuously variable transmission state at a relatively early stage when the state of charge of the power storage device 40 is insufficient, and can thus cause the rotator 30 to generate power and store it into the power storage device 40. Moreover, the ECU 50 shifts the state of the gear box 1 to the continuously variable transmission state when the operating point A goes out of the optimal fuel efficiency area TB while the optimal fuel efficiency area TB is selected with the adequate state of charge of the power storage device 40.

The ECU 50 can thus control the engine 4 and the rotator 30 on the basis of the charged state of the power storage device 40, relatively decrease the amount of power generated by the rotator 30 when the state of charge of the power storage device 40 is relatively high, and relatively increase the amount of power generated by the rotator 30 when the state of charge of the power storage device 40 is relatively low. As a result, the ECU 50 can maintain the state of charge of the power storage device 40 properly.

When the gear box 1 is in the continuously variable transmission state in the power train 3 to which the gear box 1 is applied, the energy output from the engine 4 is consumed as energy for driving the vehicle 2 and energy for generating power in the rotator 30. Now, in the continuously variable transmission state, the ECU 50 controls output of the engine 4 such that the operating point of the engine 4 is positioned within the optimal fuel efficiency areas TA, TB, and TC of the engine 4 selected according to the state of charge of the power storage device 40, namely positioned on the optimal fuel efficiency line L21 in this case, while allowing for the amount of power generated by the rotator 30. That is, the ECU 50 controls the engine 4 to output extra power commensurate with the amount absorbed by the rotator 30 when the gear box 1 is in the continuously variable transmission state. The ECU 50 can thus realize proper acceleration performance commensurate with the acceleration performance requested by a driver of the vehicle 2 and ensure favorable engine performance while at the same time causing the rotator 30 to generate power appropriately. As a result, the ECU 50 can increase the fuel efficiency and ensure the favorable engine performance at the same time.

Furthermore, when the state of charge of the power storage device 40 hits a preset allowable lower limit value or lower while the vehicle 2 is driven by the rotary power output from the rotator 30, the ECU 50 can perform control to increase output of the engine 4 relatively to a case where the state of charge of the power storage device 40 is higher than the allowable lower limit value, and cause the rotator 30 to generate power by the power generated by the engine 4 and store it into the power storage device 40. The allowable lower limit value being a lower threshold set to the state of charge of the power storage device 40 may be set in advance on the basis of the actual vehicle evaluation or the like, and is set on the basis of the chargeable charge capacity with which the power storage device 40 does not over-discharge, for example. In this case, the ECU 50 immediately shifts the gear box 1 to the continuously variable transmission state and relatively increases the output of the engine 4 so that power is generated in the rotator 30 by using the power generated by the engine 4 and is stored into the power storage device 40. At this time, the ECU 50 may restart the engine 4 and relatively increase the output thereof, when the engine 4 is in the non-operating state. The ECU 50 can as a result suppress over-discharge of the power storage device 40 and extend the life of the power storage device 40, for example.

Next, there will be described an example of control performed by the ECU 50 with reference to a flowchart in FIG. 4. Note that these control routines are repeatedly executed with a control period of every several milliseconds to tens of milliseconds (the same applies hereinafter).

First, the ECU 50 detects and monitors the charged state of the power storage device 40 on the basis of the result detected by the charge state detector of the vehicle state detection device 51 (step ST1).

The ECU 50 then determines whether or not the state of charge (SOC) of the power storage device 40 is higher than or equal to the preset allowable upper limit value (step ST2). When determining that the state of charge of the power storage device 40 is higher than or equal to the allowable upper limit value (step ST2: Yes), the ECU 50 controls the gear box 1 and the engine 4 to immediately switch the driving mode of the vehicle 2 to the EV driving mode (step ST11) and shifts to processing in step ST15.

When determining that the state of charge of the power storage device 40 is lower than the allowable upper limit value (step ST2: No), the ECU 50 determines whether or not the optimal fuel efficiency area corresponding to the current state of charge of the power storage device 40 is the optimal fuel efficiency area TC (step ST3).

Here, the ECU 50 sets the optimal fuel efficiency area corresponding to the state of charge of the power storage device 40 on the basis of an optimal fuel efficiency area map illustrated in FIG. 5 (or a mathematical model equivalent thereto), for example. The optimal fuel efficiency area map illustrated in FIG. 5 includes a horizontal axis representing the state of charge (SOC) and a vertical axis representing the optimal fuel efficiency area. The optimal fuel efficiency area map illustrates the relationship between the state of charge of the power storage device 40 and the optimal fuel efficiency area selected. The optimal fuel efficiency area map is stored in the storage unit of the ECU 50 upon setting in advance the relationship between the state of charge of the power storage device 40 and the optimal fuel efficiency areas TA, TB, and TC on the basis of the actual vehicle evaluation or the like. In the optimal fuel efficiency area map, the optimal fuel efficiency area is set such that the optimal fuel efficiency area TA, the optimal fuel efficiency area TB, and the optimal fuel efficiency area TC are set in this order from the lower (smaller) state of charge Moreover, in the optimal fuel efficiency area map, the upper state of charge for the optimal fuel efficiency area TC corresponds to the aforementioned allowable upper limit value, whereas the lower state of charge for the optimal fuel efficiency area TA corresponds to the aforementioned allowable lower limit value. The ECU 50 determines, from the optimal fuel efficiency area map, the optimal fuel efficiency area corresponding to the current state of charge of the power storage device 40 on the basis of the current state of charge of the power storage device 40. The ECU 50 determines in step ST3 whether or not the optimal fuel efficiency area corresponding to the current state of charge of the power storage device 40 is the optimal fuel efficiency area TC, on the basis of the current state of charge of the power storage device 40 and the optimal fuel efficiency area map illustrated in FIG. 5.

When determining that the optimal fuel efficiency area corresponding to the current state of charge of the power storage device 40 is the optimal fuel efficiency area TC (step ST3: Yes), the ECU 50 selects the optimal fuel efficiency area TC as the optimal fuel efficiency area (step ST4) and shifts to processing in step ST9.

On the other hand, the ECU 50 determines whether or not the optimal fuel efficiency area corresponding to the current state of charge of the power storage device 40 is the optimal fuel efficiency area TB (step ST5), upon determining that the optimal fuel efficiency area corresponding to the current state of charge of the power storage device 40 is not the optimal fuel efficiency area TC (step ST3: No).

When determining that the optimal fuel efficiency area corresponding to the current state of charge of the power storage device 40 is the optimal fuel efficiency area TB (step ST5: Yes), the ECU 50 selects the optimal fuel efficiency area TB as the optimal fuel efficiency area (step ST6) and shifts to processing in step ST9.

On the other hand, the ECU 50 determines whether or not the optimal fuel efficiency area corresponding to the current state of charge of the power storage device 40 is the optimal fuel efficiency area TA (step ST7), upon determining that the optimal fuel efficiency area corresponding to the current state of charge of the power storage device 40 is not the optimal fuel efficiency area TB (step ST5: No).

When determining that the optimal fuel efficiency area corresponding to the current state of charge of the power storage device 40 is the optimal fuel efficiency area TA (step ST7: Yes), the ECU 50 selects the optimal fuel efficiency area TA as the optimal fuel efficiency area (step ST8) and shifts to processing in step ST9.

The ECU 50 in step ST9 grasps the driving state of the vehicle 2 on the basis of the result detected by the vehicle state detection device 51 (step ST9). The ECU 50 for example uses the vehicle state detection device 51 to grasp information related to the engine 4 such as the engine speed and the throttle position, information related to the gear box 1 such as a current gear position/gear ratio, rotational speed of each unit, and a gear shift map, information related to the vehicle 2 in general such as the accelerator position, the speed of the vehicle 2, and vehicle acceleration, and information related to braking such as whether or not a brake operation is performed in the vehicle 2.

Next, the ECU 50 determines whether or not an amount of change in the throttle position is larger than or equal to the steadiness determining reference value (step ST10). The ECU 50 as a result determines whether or not the vehicle 2 is in the steady driving state, namely whether or not the engine 4 is in a low load state in which the efficiency of the engine 4 tends to be relatively decreased. Note that while the ECU 50 determines whether or not the vehicle 2 is in the steady driving state by determining whether or not the amount of change in the throttle position is larger than or equal to the steadiness determining reference value in this case, it may also be adapted to determine whether or not the engine 4 is in the low load state by determining whether or not a value of the throttle position itself is larger than or equal to a steadiness determining reference value for the throttle position, for example.

The ECU 50 controls the gear box 1 and the engine 4, switches the driving mode of the vehicle 2 to the EV driving mode (step ST11), and shifts to processing in step ST15 when determining that the amount of change in the throttle position is smaller than the steadiness determining reference value (step ST10: No), namely determining that the vehicle 2 is in the steady driving state (low load state).

On the other hand, the ECU 50 controls the gear box 1 and the engine 4 and switches the driving mode of the vehicle 2 to the engine driving mode (step ST12) when determining that the amount of change in the throttle position is larger than or equal to the steadiness determining reference value (step ST10: Yes), namely determining that the vehicle 2 is not in the steady driving state (low load state).

The ECU 50 then determines whether or not a current operating point determined from the current engine speed and engine torque is positioned within the optimal fuel efficiency area (such as the optimal fuel efficiency area TA, TB, or TC in FIG. 3) selected by the processing performed in step ST4, ST6, or ST8 (step ST13).

When determining that the current operating point is positioned within the optimal fuel efficiency area (step ST13: Yes), the ECU 50 controls the gear box 1, switches the gear box 1 to the stepped transmission state (step ST14), and shifts to processing in step ST15. In this case, the ECU 50 selects any gear position included in either the odd-numbered gear position group 11 or the even-numbered gear position group 12 according to the driving state of the vehicle 2.

The ECU 50 in step ST15 determines whether or not a brake (braking system) of the vehicle 2 is operated in response to the brake operation or the like performed by the driver (step ST15), namely whether or not the vehicle 2 is in a decelerating state.

The ECU 50 controls the gear box 1, switches the driving mode of the vehicle 2 to the regenerative driving mode (step ST16), and returns to the processing in step ST15 to repeat the shift processing when determining that the brake of the vehicle 2 is operated (step ST15: Yes), namely determining that the vehicle 2 is in the decelerating state.

On the other hand, the ECU 50 ends the current control period and shifts to a next control period when determining that the brake of the vehicle 2 is not operated (step ST15: No).

When determining in step ST13 that the current operating point is positioned outside the optimal fuel efficiency area (step ST13: No), the ECU 50 determines whether or not the current operating point is positioned within an area with the lower engine speed and the higher engine torque than the optimal fuel efficiency line L21 (such as an area on the upper side of the optimal fuel efficiency line L21 in FIG. 3) (step ST17).

When determining that the current operating point is not positioned within the area with the lower engine speed and the higher engine torque than the optimal fuel efficiency line L21 (step ST17: No), the ECU 50 controls the gear box 1, switches the gear box 1 to the continuously variable transmission state (step ST18), and shifts to processing in step ST15. In this case, the ECU 50 adjusts the amount of power generated by the rotator 30 and controls the gear ratio in the continuously variable transmission state according to the driving state of the vehicle 2.

When determining that the current operating point is positioned within the area with the lower engine speed and the higher engine torque than the optimal fuel efficiency line L21 (step ST17: Yes), the ECU 50 controls the gear box 1 and the engine 4, switches the driving mode of the vehicle 2 to the HV driving mode (step ST19), and shifts to processing in step ST15. The ECU 50 as a result performs control to assist the engine 4 by the rotary power output from the rotator 30. In this case, the ECU 50 may also perform control to assist the engine 4 by power running the rotator 30 upon shifting the gear box 1 to the engaged state equivalent to the continuously variable transmission state, for example. The ECU 50 for example performs output control in order for the operating point of the engine 4 to be positioned on the optimal fuel efficiency line L21 and compensates for the shortage of power by causing the rotator 30 to assist by power running.

Similar to the processing performed in step ST9, the ECU 50 grasps the driving state of the vehicle 2 on the basis of the result detected by the vehicle state detection device 51 (step ST20) when determining in step ST7 that the optimal fuel efficiency area corresponding to the current state of charge of the power storage device 40 is not the optimal fuel efficiency area TA (step ST7: No), or determining that the state of charge of the power storage device 40 is lower than or equal to the allowable lower limit value. The ECU 50 thereafter shifts to processing in step ST18 and controls the gear box 1 to be switched to the continuously variable transmission state (step ST18). As a result, the ECU 50 can immediately shift the gear box 1 to the continuously variable transmission state and charge the power generated by the rotator 30 into the power storage device 40 when determining that the state of charge of the power storage device 40 is lower than or equal to the allowable lower limit value.

The aforementioned gear box 1 and ECU 50 are configured to connect the rotator 30 to the first input shaft 13 and the second input shaft 14 of the gear shift mechanism 10 being the DCT through the differential mechanism 20, control the first engaging device C1 and the second engaging device C2, and control the differential rotation of the two shafts by the rotator 30. The gear box 1 and the ECU 50 can therefore switch the state of the gear box 1 between the dual-clutch stepped transmission state and the continuously variable transmission state. As a result, the gear box 1 and the ECU 50 can realize driving close to the optimal fuel efficiency line of the CVT in the DCT and increase the fuel efficiency.

The ECU 50 of the present embodiment can realize control that drives the vehicle 2 by the rotary power output from the rotator 30 by controlling the third engaging device C0 and the rotator 30 and setting the third engaging device C0 to be in the disengaged state in an area of operation in which the efficiency of the engine 4 is relatively poor, for example. The ECU 50 can therefore use the rotary power output from the rotator 30 to drive the vehicle 2. As a result, the gear box 1 and the ECU 50 can efficiently use the surplus power or the like accumulated in the power storage device 40 and drive the vehicle 2 upon preventing the engine 4 from being operated in the area of operation in which the engine efficiency is poor according to the driving state of the vehicle 2. The gear box 1 and the ECU 50 can therefore process the surplus power efficiently, prevent waste of energy, and increase the fuel efficiency. Moreover, when driving the vehicle 2 in the EV driving mode by using the rotary power output from the rotator 30, the gear box 1 and the ECU 50 can separate the engine 4 from the power transmission device 5 by setting the third engaging device C0 to be in the disengaged state. The gear box 1 and the ECU 50 can therefore reduce the friction loss of the engine 4, increase the driving efficiency by the rotator 30, and further increase the fuel efficiency.

Furthermore, the ECU 50 can optimally perform powering, power generation, and charging by the rotator 30 by switching the driving mode of the vehicle 2 on the basis of the charged state of the power storage device 40 and the driving state of the vehicle 2 and switching the gear shift state of the gear box 1 as appropriate. As a result, the gear box 1 and the ECU 50 can properly maintain the state of charge of the power storage device 40 to increase both the fuel efficiency and the life of the power storage device 40, for example. Moreover, the gear box 1 and the ECU 50 can properly maintain the state of charge of the power storage device 40 so that oversizing of the power storage device 40 can be prevented, mountability can be improved, a manufacturing cost can be cut down, and a vehicle mass can be decreased, thereby allowing the fuel efficiency to be increased in this respect as well.

FIG. 6 is a diagram illustrating an example of the operation of the gear box 1 configured as described above. The diagram illustrated in FIG. 6 includes a horizontal axis representing a time axis and a vertical axis representing, from top to bottom, the vehicle speed, the engine efficiency, and the amount of power generated/discharged in/from the rotator. Moreover, three cases are illustrated for the amount of power generated/discharged in/from the rotator including, from top to bottom, a case where the optimal fuel efficiency area TA is selected, a case where the optimal fuel efficiency area TB is selected, and a case where the optimal fuel efficiency area TC is selected.

Once the vehicle 2 starts accelerating at time t1 as illustrated in FIG. 6, the gear box 1 and the ECU 50 of the present embodiment cause the rotator 30 to generate power and charge it into the power storage device 40 when the state of charge of the power storage device 40 is insufficient with the optimal fuel efficiency area TA being selected and when the state of charge of the power storage device 40 is adequate with the optimal fuel efficiency area TB being selected. When the state of charge of the power storage device 40 is excessive with the optimal fuel efficiency area TC being selected, on the other hand, the gear box 1 and the ECU 50 properly process the surplus power by causing the rotator 30 to discharge (perform powering) and using the surplus power to drive the vehicle 2 in the EV driving mode even in the area of operation in which the efficiency of the engine 4 is relatively high. The gear box 1 and the ECU 50 operate in the same manner when the vehicle is accelerated from time t5 to time t6 and from time t7 to time t8. However, when the state of charge of the power storage device 40 falls below the allowable lower limit value while the vehicle is accelerated from time t5 to time t6 with the optimal fuel efficiency area TC being selected, the gear box 1 and the ECU 50 switch the state of the rotator 30 from the discharging (powering) state to the power generation state so that the power is charged into the power storage device 40 (the same applies to the acceleration from time t7 to time t8).

Once the vehicle 2 shifts to steady drive at time t2, the gear box 1 and the ECU 50 cause the rotator 30 to discharge (perform powering) and drive the vehicle 2 in the EV driving mode in any case since the efficiency of the engine 4 becomes relatively low. When the optimal fuel efficiency area TA is selected, the state of charge of the power storage device 40 falls below the allowable lower limit value early compared to another case, so that the gear box 1 and the ECU 50 switch the state of the rotator 30 from the discharging (powering) state to the power generation state once the allowable lower limit value falls below the state of charge and charge the power into the power storage device 40. The gear box 1 and the ECU 50 operate in the same manner when the vehicle is driven steadily from time t6 to time t7 and from time t8 to time t9.

Once the vehicle 2 starts decelerating at time t3, the gear box 1 and the ECU 50 cause the rotator 30 to generate power, charge it into the power storage device 40 and drive the vehicle 2 in the regenerative driving mode until the vehicle 2 comes to a stop at time t4. The gear box 1 and the ECU 50 operate in the same manner when the vehicle is decelerated from time t9 to time t10.

Therefore, the gear box 1 and the ECU 50 of the present embodiment can optimally perform powering, power generation, and charging of the rotator 30 by controlling the engine 4, the first engaging device C1, the second engaging device C2, the third engaging device C0 and the rotator 30, switching the driving mode of the vehicle 2 and switching the gear shift state of the gear box 1 as appropriate on the basis of the charged state of the power storage device 40 and the driving state of the vehicle 2. As a result, the gear box 1 and the ECU 50 can maintain the state of charge of the power storage device 40 properly.

The gear box 1 and the ECU 50 according to the embodiment described above can properly use the dual-clutch stepped transmission state and the continuously variable transmission state according to the situation and drive the vehicle 2 with the rotary power output from the rotator 30 by using the power accumulated in the power storage device 40, whereby the fuel efficiency can be increased.

### Second Embodiment

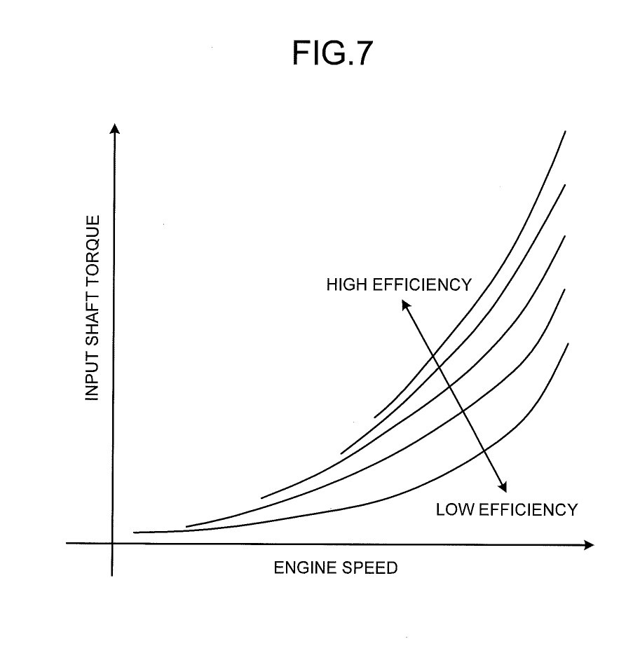

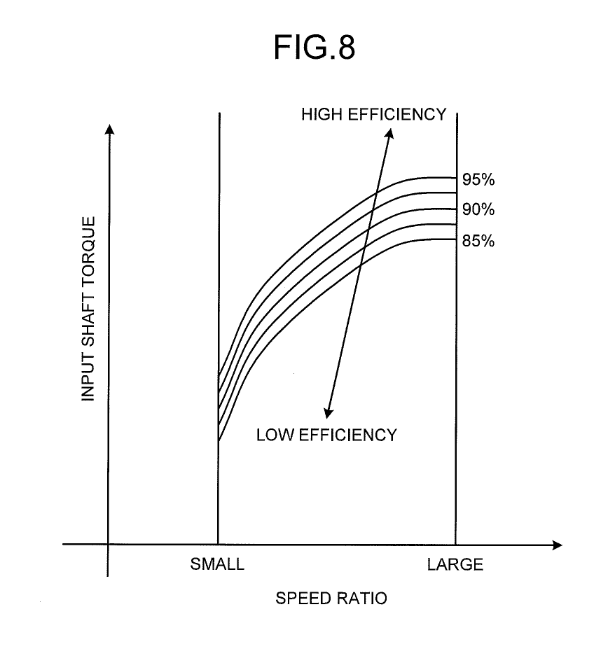

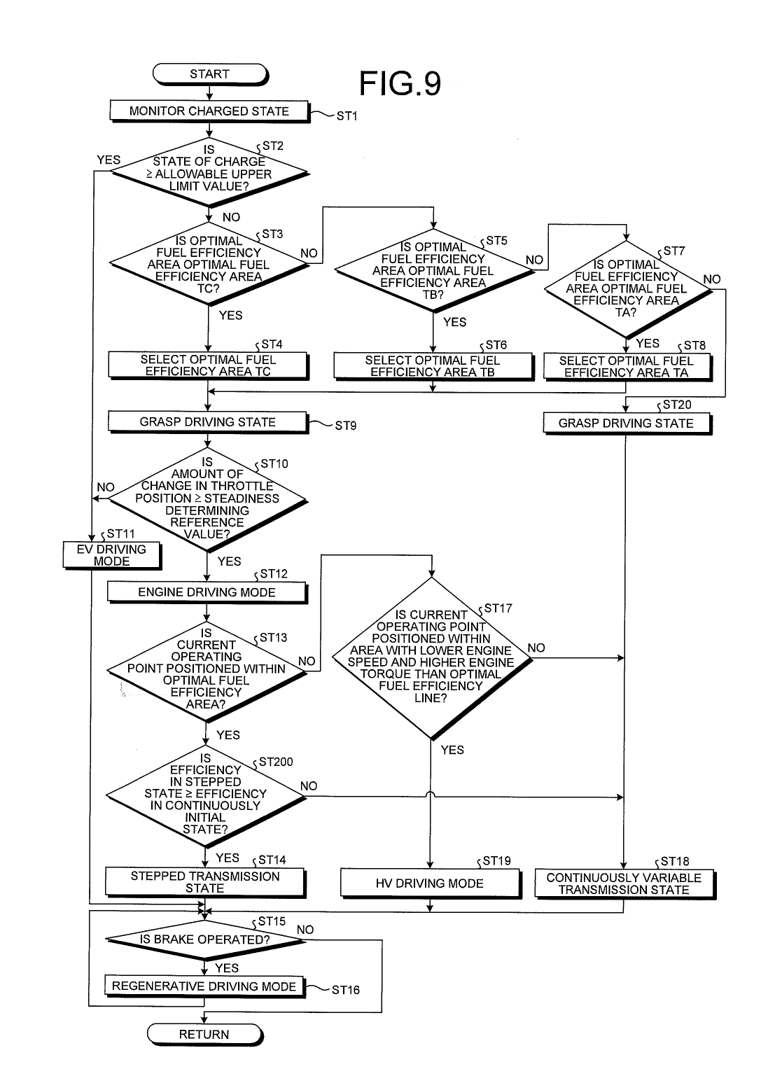

FIG. 7 is a diagram illustrating an example of a gear position efficiency map for a gear box according to a second embodiment. FIG. 8 is a diagram illustrating an example of a differential mechanism efficiency map for the gear box according to the second embodiment. FIG. 9 is a flowchart illustrating an example of control performed in the gear box according to the second embodiment. A vehicle gear box and a control system according to the second embodiment can switch the state of a vehicle between a stepped transmission state and a continuously variable transmission state according to efficiency and are thus different from those of the first embodiment. Description of the configuration, operation and effect common to those of the aforementioned embodiment will not be repeated where possible (the same applies to an embodiment described below). Moreover, FIG. 1 or the like may be referenced as appropriate to see the configuration of each of the vehicle gear box and the control system according to the second embodiment.

An ECU 50 of the present embodiment can perform control such that a gear box 201 being the vehicle gear box is switched to the state with relatively higher efficiency between the stepped transmission state and the continuously variable transmission state. Typically, the ECU 50 can perform control such that the gear box is switched to the state with relatively higher efficiency between the stepped transmission state and the continuously variable transmission state while an operating point of engine speed and engine torque is positioned within the optimal fuel efficiency area described above. In this case, the ECU 50 compares the efficiency in the stepped transmission state with the efficiency in the continuously variable transmission state, and controls the gear box 201 to be in the state with higher efficiency. Note that the efficiency typically refers to total efficiency in a power train 3 where at least the efficiency of an engine 4 and power transmission efficiency of the gear box 201 (gear shift mechanism 10) are included.

There will be described an example where a vehicle 2 starts moving and accelerates while a first gear position (1st) 61 is selected in the stepped transmission state. In this case, the ECU 50 calculates efficiency at an operating point (such as an operating point on a dotted line L35 in FIG. 3) before shifted to a second gear position (2nd) 62 as the efficiency of the first gear position 61 being the current gear position. The ECU 50 for example uses various known methods to detect current engine speed and engine torque on the basis of a result detected by an engine speed sensor and a throttle position sensor, and can specify a current operating point on the basis of the current engine speed and engine torque. The ECU 50 then specifies as the efficiency pertinent to a gear ratio of a current gear position to a next gear position, namely as the efficiency in a wireless transmission state, an operating point which is a point of intersection of an equal output line passing through the current operating point specified and an optimal fuel efficiency line L21 illustrated in FIG. 3, and calculates the efficiency at a predicted operating point in the continuously variable transmission state. That is, the ECU 50 calculates the efficiency at the predicted operating point in the continuously variable transmission state, the predicted operating point having output equal to that of the current operating point on the optimal fuel efficiency line L21.

It can be considered in this case that efficiency other than the efficiency of the engine 4 and the power transmission efficiency of the gear box 201 is roughly the same at the current operating point and the predicted operating point in the continuously variable transmission state. Accordingly, the ECU 50 compares efficiency ηa at the current operating point with efficiency ηb at the predicted operating point in the continuously variable transmission state on the basis of the efficiency of the engine 4 and the transmission efficiency of the gear box 201. The transmission efficiency of the gear box 201 in the stepped transmission state can be calculated on the basis of gear position efficiency. The gear position efficiency is the power transmission efficiency of each gear position included in an odd-numbered gear position group 11 and an even-numbered gear position group 12. On the other hand, the transmission efficiency of the gear box 201 in the continuously variable transmission state can be calculated on the basis of differential mechanism efficiency in addition to the gear position efficiency. The differential mechanism efficiency is the power transmission efficiency of a differential mechanism 20. Accordingly, the ECU 50 uses expressions (1) and (2) below to be able to calculate the efficiency ηa at the current operating point in the stepped transmission state and the efficiency ηb at the predicted operating point in the continuously variable transmission state.

ηa=engine efficiency×gear position efficiency (1)

ηb=engine efficiency×gear position efficiency×differential mechanism efficiency (2)

The ECU 50 may calculate the efficiency of the engine 4 for each of the current operating point and the predicted operating point in the continuously variable transmission state on the basis of the operating characteristic map (or a mathematical model equivalent thereto) illustrated in FIG. 3, for example. The operating characteristic map is prepared beforehand in accordance with the actual vehicle evaluation or the like and stored in a storage unit.

Moreover, the ECU 50 may calculate the gear position efficiency at each of the current operating point and the predicted operating point in the continuously variable transmission state on the basis of a gear position efficiency map (or a mathematical model equivalent thereto) illustrated in FIG. 7, for example. The gear position efficiency map illustrated in FIG. 7 includes a horizontal axis representing the engine speed and a vertical axis representing the input shaft torque input to each gear position. Here, the input shaft torque corresponds to the torque input to the first input shaft 13 when the gear box 201 transmits power along a first route R1 (refer to FIG. 2) or a fourth route R4 (refer to FIG. 2). On the other hand, the input shaft torque corresponds to the torque input to the second input shaft 14 when the gear box 201 transmits power along a second route R2 (refer to FIG. 2) or a third route R3 (refer to FIG. 2). The gear position efficiency map illustrates the relationship among the engine speed, the input shaft torque, and the gear position efficiency. The gear position efficiency map is stored in advance as a three-dimensional map into the storage unit of the ECU 50 upon presetting the relationship between the input shaft torque and the gear position efficiency for each engine speed on the basis of the actual vehicle evaluation or the like. On the gear position efficiency map, the gear position efficiency is decreased relatively to the increase in the engine speed, and increased relatively to the increase in the input shaft torque. The ECU 50 then calculates the input shaft torque at each operating point on the basis of the engine speed and engine torque at each operating point as well as various results detected by the vehicle state detection device 51. Then, the ECU 50 calculates the gear position efficiency at each operating point from the engine speed and input shaft torque at each operating point, on the basis of the gear position efficiency map. Note that the gear position efficiency map is not limited to what is illustrated in FIG. 7.

Moreover, the ECU 50 may calculate the differential mechanism efficiency at the predicted operating point in the continuously variable transmission state on the basis of a differential mechanism efficiency map (or a mathematical model equivalent thereto) illustrated in FIG. 8, for example. The differential mechanism efficiency map illustrated in FIG. 8 includes a horizontal axis representing a speed ratio of the differential mechanism 20 and a vertical axis representing the input shaft torque input to the differential mechanism 20. Here, the input shaft torque corresponds to the torque input to the first input shaft 13 when the gear box 201 transmits power along a third route R3 (refer to FIG. 2). On the other hand, the input shaft torque corresponds to the torque input to the second input shaft 14 when the gear box 201 transmits power along a fourth route R4 (refer to FIG. 2). The speed ratio corresponds to [rotational speed of the second input shaft 14/rotational speed of the first input shaft 13] when the gear box 201 transmits power along the third route R3 (refer to FIG. 2). On the other hand, the speed ratio corresponds to [rotational speed of the first input shaft 13/rotational speed of the second input shaft 14] when the gear box 201 transmits power along the fourth route R4 (refer to FIG. 2). The differential mechanism efficiency in this case includes power loss acting upon the rotator 30. The differential mechanism efficiency map illustrates the relationship among the speed ratio, the input shaft torque, and the differential mechanism efficiency. The differential mechanism efficiency map is stored in advance as a three-dimensional map into the storage unit of the ECU 50 upon presetting the relationship between the input shaft torque and the differential mechanism efficiency for each speed ratio on the basis of the actual vehicle evaluation or the like. On the differential mechanism efficiency map, the differential mechanism efficiency is increased relatively to the decrease in the speed ratio, and increased relatively to the increase in the input shaft torque. The ECU 50 then calculates the input shaft torque and the speed ratio at the predicted operating point in the continuously variable transmission state on the basis of the engine speed and engine torque at the predicted operating point as well as various results detected by the vehicle state detection device 51 such as the first input shaft rotational speed and the second input shaft rotational speed. Then, the ECU 50 calculates the differential mechanism efficiency at the operating point from the speed ratio and input shaft torque at the operating point, on the basis of the differential mechanism efficiency map. Note that the differential mechanism efficiency map is not limited to what is illustrated in FIG. 8.

On the basis of the engine efficiency, the gear position efficiency and the differential mechanism efficiency calculated above, the ECU 50 calculates the efficiency ηa at the current operating point in the stepped transmission state and the efficiency ηb at the predicted operating point in the continuously variable transmission state while using expressions (1) and (2). The ECU 50 then compares the efficiency ηa with the efficiency ηb and controls the gear box 201 to be in the state with higher efficiency.

Next, there will be described an example of control performed by the ECU 50 with reference to a flowchart in FIG. 9. Note that the description made with reference to FIG. 4 will not be repeated where possible.

When determining in step ST13 that the current operating point is positioned within the optimal fuel efficiency area (step ST13: Yes), the ECU 50 determines whether or not the efficiency of the gear box 201 in the stepped transmission state is higher than or equal to the efficiency in the continuously variable transmission state (step ST200). The ECU 50 calculates the efficiency of the gear box 201 in the stepped transmission state and the efficiency in the continuously variable transmission state as described above and compares the efficiencies.

When determining that the efficiency of the gear box 201 in the stepped transmission state is higher than or equal to the efficiency in the continuously variable transmission state (step ST200: Yes), the ECU 50 controls the gear box 201, switches the gear box 201 to the stepped transmission state (step ST14), and shifts to processing in step ST15.

On the other hand, the ECU 50 controls the gear box 201, switches the gear box 201 to the continuously variable transmission state (step ST18), and shifts to the processing in step ST15 when determining that the efficiency of the gear box 201 in the stepped transmission state is lower than the efficiency in the continuously variable transmission state (step ST200: No).

The gear box 201 and the ECU 50 according to the embodiment described above can properly use the dual-clutch stepped transmission state and the continuously variable transmission state according to the situation and drive the vehicle 2 with the rotary power output from the rotator 30 by using the power accumulated in the power storage device 40, whereby the fuel efficiency can be increased.

Moreover, the gear box 201 and the ECU 50 according to the embodiment described above compare the efficiency in the stepped transmission state with the efficiency in the continuously variable transmission state and perform control to shift the state to the one with relatively higher efficiency, whereby the effect of increase in the fuel efficiency can be further enhanced.

### Third Embodiment

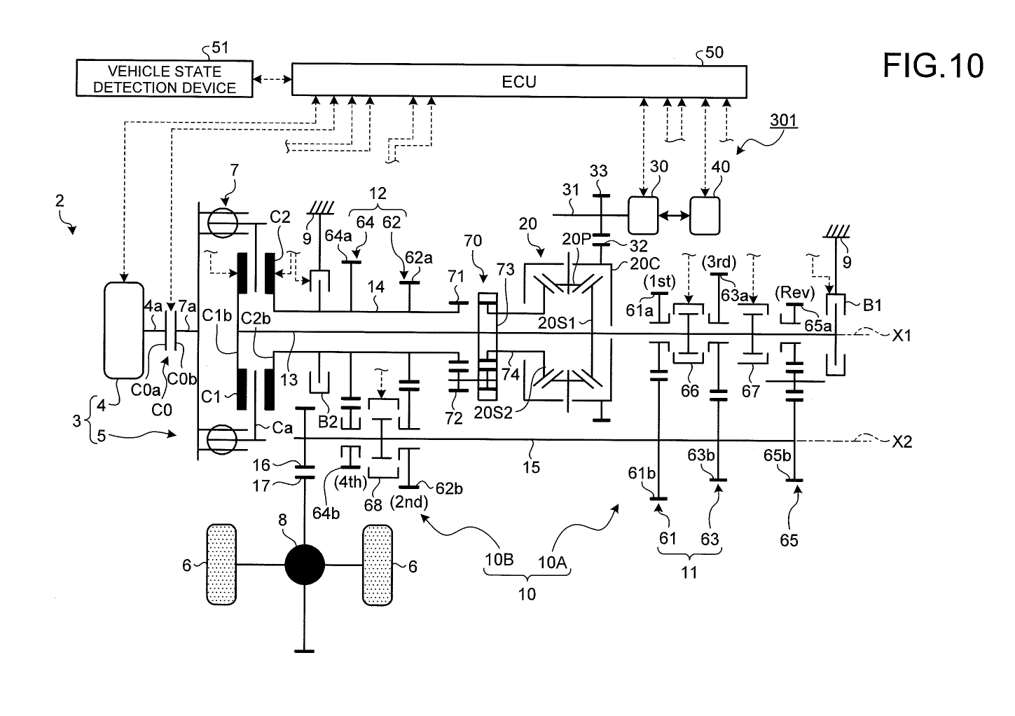

FIG. 10 is a schematic block diagram of a vehicle equipped with a gear box according to a third embodiment. A vehicle gear box and a control system of the third embodiment are different from those of the first and second embodiments in that a first brake and a second brake are provided.

A gear box 301 being the vehicle gear box of the present embodiment includes, as illustrated in FIG. 10, a first brake B1 and a second brake B2 in addition to a dual-clutch gear shift mechanism 10 including a first engaging device C1 and a second engaging device C2, a differential mechanism 20, a rotator 30, a power storage device 40, a third engaging device C0, and an ECU 50.

The first brake B1 can brake the rotation of a first input shaft 13. The first brake B1 is provided between a fixed portion such as a casing 9 and the first input shaft 13 to be able to engage/disengage connection between the casing 9 and the first input shaft 13. The first brake B1 can be switched between a braking state (engaged state) in which the casing 9 and the first input shaft 13 are engaged to stop the rotation of the first input shaft 13 and a disengaged state in which the engagement is released. The second brake B2 can brake the rotation of a second input shaft 14. The second brake B2 is provided between the casing 9 and the second input shaft 14 to be able to engage/disengage connection between the casing 9 and the second input shaft 14. The second brake B2 can be switched between a braking state (engaged state) in which the casing 9 and the second input shaft 14 are engaged to stop the rotation of the second input shaft 14 and a disengaged state in which the engagement is released. An automatic clutch device can be used for the first brake B1 and the second brake B2, for example, but another device may be used as well. The first brake B1 and the second brake B2 can be switched to the braking state or the disengaged state by an actuator that is actuated by hydraulic pressure or the like. The first brake B1 and the second brake B2 can be controlled to be in a fully braked state, a semi-braked state, or the disengaged state depending on the hydraulic pressure supplied.

When setting the third engaging device C0 to be in the disengaged state and driving the vehicle 2 by the rotary power output from the rotator 30 as in an EV driving mode, the ECU 50 controls the first brake B1 and the second brake B2 to be in the braking/disengaged states. The ECU 50 controls the first brake B1 to be in the disengaged state and the second brake B2 to be in the braking state when shifting the speed of the rotary power from the rotator 30 by any gear position included in an odd-numbered gear position group 11. On the other hand, the ECU 50 controls the first brake B1 to be in the braking state and the second brake B2 to be in the disengaged state when shifting the speed of the rotary power from the rotator 30 by any gear position included in an even-numbered gear position group 12.

The gear box 301 can thus cause the second brake B2 to receive reaction force in transmitting power to a driving wheel 6 through any gear position included in the odd-numbered gear position group 11 and cause the first brake B1 to receive reaction force in transmitting power to the driving wheel 6 through any gear position included in the even-numbered gear position group 12, when the third engaging device C0 is set to be in the disengaged state to drive the vehicle 2 with the rotary power output from the rotator 30. As a result, the gear box 301 can shift in speed the rotary power from the rotator 30 by any gear position included in either the odd-numbered gear position group 11 or the even-numbered gear position group 12 and output the power from an output shaft 15 to be transmitted to the driving wheel 6.

The gear box 301 and the ECU 50 according to the embodiment described above can properly use the dual-clutch stepped transmission state and the continuously variable transmission state according to the situation and drive the vehicle 2 with the rotary power output from the rotator 30 by using the power accumulated in the power storage device 40, whereby the fuel efficiency can be increased.

Moreover, the gear box 301 and the ECU 50 according to the embodiment described above can cause the first brake B1 or the second brake B2 to receive reaction force when driving the vehicle in the EV driving mode, so that the rotary power from the rotator 30 can be output from the output shaft 15 through any gear position included in the odd-numbered gear position group 11 or the even-numbered gear position group 12, and be transmitted to the driving wheel 6. As a result, the gear box 301 and the ECU 50 can use the rotary power output from the rotator 30 to drive the vehicle 2 appropriately.

Note that the vehicle gear box and the control system according to the aforementioned embodiments of the present invention are not to be limited to what is described in the aforementioned embodiments, where various modifications can be made within the scope of claims. The vehicle gear box and the control system according to the present embodiment may be configured by combining the components of each of the aforementioned embodiments as appropriate.

While the differential mechanism 20 described above is configured where the first sun gear 20S1 is the element connected to the first input shaft 13, the second sun gear 20S2 is the element connected to the second input shaft 14, and the carrier 20C is the element connected to the rotational shaft 31 of the rotator 30, the combination of each rotating component and the first input shaft 13, the second input shaft 14 and the rotational shaft 31 is not limited to what is described above.

While the ECU 50 doubles as the control system of the vehicle gear box in the aforementioned description, it is not limited to such case. The control system may, for example, be configured separately from the ECU 50 to mutually transmit/receive information such as a detection signal, a drive signal and a control command.

### REFERENCE SIGNS LIST

1, 201, 301 gear box (vehicle gear box)
2 vehicle
4 engine
6 driving wheel
10 gear shift mechanism
10A odd-numbered gear shifting unit
10B even-numbered gear shifting unit
11 odd-numbered gear position group (first gear position group)
12 even-numbered gear position group (second gear position group)
13 first input shaft
14 second input shaft
15 output shaft
20 differential mechanism
30 rotator
31 rotational shaft
40 power storage device
50 ECU (control system)
B1 first brake
B2 second brake
C0 third engaging device
C1 first engaging device
C2 second engaging device

1. A vehicle gear box comprising:
a gear shift mechanism including:
a first engaging device configured to engage/disengage power transmission between an engine generating rotary power that drives a vehicle and a first input shaft of a first gear position group; and
a second engaging device configured to engage/disengage power transmission between the engine and a second input shaft of a second gear position group;
a differential mechanism configured to connect a rotational shaft of a rotator and the first input shaft and the second input shaft to be able to rotate differentially;
a third engaging device configured to engage/disengage power transmission between the engine and the first engaging device and the second engaging device; and
a control system configured to control the engine, the first engaging device, the second engaging device, the third engaging device, and the rotator,
wherein the control system is configured to control the third engaging device and the rotator to perform control that switches the third engaging device to be in a disengaged state and drives the vehicle by the rotary power output from the rotator.

2. The vehicle gear box according to claim 1, wherein the control system controls the engine and the rotator on the basis of a charged state of a power storage device configured to store power generated by the rotator, and to perform control that, at a time a state of charge of the power storage device is relatively high, decreases output of the engine relatively to a case where a state of charge of the power storage device is relatively low and drives the vehicle with rotary power output from the rotator.

3. The vehicle gear box according to claim 1, wherein the control system controls the first engaging device, the second engaging device, and the rotator to be able to switch a state between a stepped transmission state in which the rotary power from the engine is shifted in speed by any gear position included in the first gear position group or the second gear position group and is output from an output shaft, and a continuously variable transmission state in which the rotary power from the engine is shifted in speed by an intermediate gear ratio of a gear ratio of each gear position included in the first gear position group and the second gear position group and is output from the output shaft and in which the gear ratio can be continuously changed, the control system being configured to perform control to switch a state to either the stepped transmission state or the continuously variable transmission state with relatively higher efficiency and changing the gear ratio by controlling an amount of power generated by the rotator at a time in the continuously variable transmission state.

4. The vehicle gear box according to claim 1, wherein the control system controls each of the first engaging device and the second engaging device to be in an engaged state at a time of driving the vehicle by the rotary power output from the rotator while setting the third engaging device to be in a disengaged state.

5. The vehicle gear box according to claim 1, further comprising:
a first brake configured to brake rotation of the first input shaft; and
a second brake configured to brake rotation of the second input shaft,
wherein, at a time of driving the vehicle by the rotary power output from the rotator while setting the third engaging device to be in the disengaged state, the control system controls the first brake and the second brake in a way that the first brake and the second brake are switched to a disengaged state and a braking state, respectively, at a time the rotary power from the rotator is shifted in speed by any gear position included in the first gear position group and that the first brake and the second brake are switched to a braking state and a disengaged state, respectively, at a time the rotary power from the rotator is shifted in speed by any gear position included in the second gear position group.

6. The vehicle gear box according to claim 1, wherein, at a time of controlling the engine and the rotator to generate power in the rotator by using power generated in the engine, the control system is configured to control output of the engine such that an operating point of the engine is positioned within an optimal fuel efficiency area of the engine while allowing for an amount of power generated by the rotator.

7. The vehicle gear box according to claim 1, wherein the control system is configured to perform control to drive the vehicle by the rotary power output from the rotator at a time the vehicle is driven steadily.

8. The vehicle gear box according to claim 7, wherein the control system determines that the vehicle is in a steady driving state at a time an amount of change in a parameter indicating a driving state of the vehicle is smaller than a preset steadiness determining reference value, which is relatively increased at a time a state of charge of a power storage device capable of storing power generated by the rotator is relatively high, and relatively decreased at a time the state of charge of the power storage device is relatively low.

9. The vehicle gear box according to claim 1, wherein the control system controls the engine and the rotator on the basis of a charged state of the power storage device capable of storing power generated by the rotator, and is configured to perform control that relatively decreases the amount of power generated by the rotator at a time the state of charge of the power storage device is relatively high and relatively increases the amount of power generated by the rotator at a time the state of charge of the power storage device is relatively low.

10. The vehicle gear box according to claim 1, wherein the control system is configured to perform control to generate power in the rotator by using power generated by the engine and store the power into the power storage device by increasing output of the engine relatively to a case where the state of charge of the power storage device is higher than a preset allowable lower limit value, at a time the state of charge of the power storage device capable of storing power generated by the rotator is lower than or equal to the allowable lower limit value while the vehicle is driven by the rotary power output from the rotator.

11. The vehicle gear box according to claim 1, wherein the control system is configured to perform control that controls the rotator to generate power by the rotary power transmitted to the rotator from the side of a driving wheel of the vehicle and stores the power into the power storage device at a time the vehicle is decelerated.

12. A control system for controlling a vehicle gear box including: a gear shift mechanism including: a first engaging device configured to engage/disengage power transmission between an engine generating rotary power that drives a vehicle and a first input shaft of a first gear position group; and a second engaging device configured to engage/disengage power transmission between the engine and a second input shaft of a second gear position group; a differential mechanism configured to connect a rotational shaft of a rotator and the first input shaft and the second input shaft to be able to rotate differentially; and a third engaging device configured to engage/disengage power transmission between the engine and the first engaging device and the second engaging device,
the control system comprising a control unit configured to control the third engaging device and the rotator to be able to perform control that switches the third engaging device to be in a disengaged state and drives the vehicle by the rotary power output from the rotator.
